(19) United States
(12) Patent Application Publication
(10) Pub. No.: US 2026/0132305 A1
(43) Pub. Date: May 14, 2026

(54) POLYETHYLENE BLEND FOR CABLE APPLICATIONS

(71) Applicant: BOREALIS AG, Vienna (AT)

(72) Inventors: Yi Liu, Linz (AT); Hermann Braun, Linz (AT); Elisabeth Ribartis, Stenungsund (SE)

(21) Appl. No.: 18/697,609

(22) PCT Filed: Oct. 6, 2022
(86) PCT No.: PCT/EP2022/077786

§ 371 Date: Apr. 1, 2024

(30) Foreign Application Priority Data
Oct. 6, 2021 (EP) 21201109.2

(51) Int. Cl. C09D 123/06; C08L 23/06; H01B 3/44

(52) U.S. Cl. CPC C09D 123/06; C08L 23/06; H01B 3/441

(57) ABSTRACT

The present invention relates to upgrading of PE recycling streams using virgin linear low-density polyethylenes (LLDPE) to give jacketing materials that have good ESCR (Environmental Stress Crack Resistance), good impact properties and high flexibility.

### FIELD OF THE INVENTION

The present invention relates to upgrading of PE recycling streams using virgin linear low-density polyethylenes (LLDPE) to give jacketing materials that have good ESCR (Environmental Stress Crack Resistance), good impact properties and high flexibility.

### BACKGROUND

Polyolefins, in particular polyethylene and polypropylene are increasingly consumed in large amounts in a wide range of applications, including packaging for food and other goods, fibres, automotive components, and a great variety of manufactured articles.

Polyethylene based materials are a particular problem as these materials are extensively used in packaging. Taking into account the huge amount of waste collected compared to the amount of waste recycled back into the stream, there is still a great potential for intelligent reuse of plastic waste streams and for mechanical recycling of plastic wastes.

Generally, recycled quantities of polyethylene on the market are mixtures of both polypropylene (PP) and polyethylene (PE), this is especially true for post-consumer waste streams. Moreover, commercial recyclates from post-consumer waste sources are conventionally cross contaminated with non-polyolefin materials, such as polyethylene terephthalate, polyamide, polystyrene or non polymeric substances like wood, paper, glass or aluminium. These cross-contaminations drastically limit final applications or recycling streams such that no profitable final uses remain.

In addition, recycled polyolefin materials normally have properties, which are much worse than those of the virgin materials, unless the amount of recycled polyolefin added to the final compound is extremely low. For example, such materials often have limited impact strength and poor mechanical properties (such as e.g. brittleness) and thus, they do not fulfil customer requirements. For several applications, e.g. jacketing materials (for cables), containers, automotive components or household articles. This normally excludes the application of recycled materials for high quality parts, and means that they are only used in low-cost, non-demanding applications, such as e.g. in construction or in furniture. In order to improve the mechanical properties of these recycled materials, generally relatively large amounts of compatibilizing/coupling agents and elastomeric polymers are added. These materials are generally virgin materials, which are produced from oil.

EP 2417194 B1 also relates to uncrosslinked polyethylene compositions for use in power cables. The compositions disclosed herein are polymer blends comprising MDPE and HDPE and one or more additive(s) selected from a flame retardant, an oxidation stabilizer, a UV stabilizer, a heat stabilizer and a process aid.

DE-102011108823-A1 relates to a composite for electrical isolation of electrical cables. The composite comprises a plastic, a material having a heat conductivity of less than 1 W/(mk) and a displacement material (C). In certain embodiments, the displacement material can be a recycled material.

EP 1676283 B1 relates to medium/high voltage electrical energy transport or distribution cables comprising at least one transmissive element and at least one coating layer, said coating layer being made from a coating material comprising at least one recycled polyethylene (obtained from a waste material) with a density not higher than 0.940 g/cm³ and at least a second polyethylene material having a density higher than 0.940 g/cm³. The coating material in some of the examples of EP 1676283 B1 showed improved values with respect to stress cracking resistance with respect to those obtained from recycled polyethylene alone. However, these values were considerably less than those obtained with the virgin material, DFDG-6059@Black.

EP 2 417 194 B1 relates to power cables comprising an non crosslinked polyethylene composition comprising 100 parts by weight of a polymer comprising 60 to 95 wt.-% of a linear medium density polyethylene resin comprising an alpha-olefin having 4 or more carbon atoms as a comonomer and having a melt index of 0.6-2.2 g/10 min (at 190° C. under a load of 5 kg), a differential scanning calorimetry (DSC) enthalpy of 130-190 joule/g and a molecular weight distribution of 2-30; and 5 to 40 wt.-% of a high-density polyethylene resin having a melt index of 0.1-0.35 g/10 min (at 190° C. under a load of 5 kg), a DSC enthalpy of 190-250 joule/g and a molecular weight distribution of 3-30; 0.1 to 10 parts by weight of one or more additive(s) selected from a flame retardant, an oxidation stabilizer, a UV stabilizer, a heat stabilizer and a process aid, based on 100 parts by weight of the polymer. None of the resins is recycled material.

Another particular problem in recycled polyethylene materials is that variations in ESCR (Environmental Stress Crack Resistance) properties can also be observed in recycled polyethylene blends depending on the waste origin. Thus, there is need for addressing these limitations in a flexible way. For jacketing applications generally an ESCR (Bell test failure time) of greater than 1000 hours is desirable.

WO 2021/122299 A1 relates to polyethylene blends comprising recycled polyethylene material which is blended with at least one virgin high density polyethylene (HDPE) resin. These blends show good ESCR behavior in the (Bell test failure time) of greater than 1000 hours and qualify for jacketing applications but show low flexibility and impact properties.

Thus, there remains a need in the art to provide recycled polyethylene solutions for wire and cable applications, especially for jacketing materials, that have acceptable and constant ESCR (Environmental Stress Crack Resistance) performance (e.g. tensile properties), with Bell test failure time >1000 hours and good impact properties in the Charpy Notched Impact Strength and high flexibility in a low flexural modulus with other properties which are similar to blends of virgin polyethylene marketed for the purpose of cable jacketing. It is also desirable to maximize the loading of recycled polyethylene material.

### SUMMARY OF THE INVENTION

The present invention provides compositions with acceptable ESCR, good impact performance and high flexibility, while maintaining other properties similar to the blend of virgin polyethylene marketed for the purpose of cable jacketing. The present invention is also concerned with maximising the loading of recycled material (with loadings of up to 85% recycled material) in the composition and with the use of a combination of specific blends of virgin polyethylene to improve the ESCR properties, impact properties and/or flexibility of a polyethylene recycling blend (A).

The inventive compositions comprise a mixed plastics polyethylene primary recycling blend and a secondary blend of virgin linear low-density polyethylene (LLDPE). The preparation of a composition with good ESCR is more challenging when using virgin LLDPE compared to virgin HDPE as disclosed in WO 2021/122299 A1 as LLDPE shows higher tendency to thermal mechanical degradation than HDPE with its higher content of tertiary carbon (Iring, M. et al. Thermal oxidation of Linear Low Density Polyethylene. Polymer Degradation and Stability 14, 319-332, 1986). This degradation process could be accelerated by the presence of the polypropylene impurity in the mixed plastics polyethylene primary recycling blend (Camacho, W. & Karlsson, S. Assessment of thermal and thermo-oxidative stability of multi-extruded recycled PP, HDPE and a blend thereof. Polym. Degrad. Stab. 78, 385-391, 2002). Hence it is more challenging to prepare a composition comprising a mixed plastics polyethylene primary recycling blend and a secondary blend of virgin linear low-density polyethylene (LLDPE) than a composition comprising a mixed plastics polyethylene primary recycling blend and a secondary blend of virgin high-density polyethylene (HDPE) without much degradation and with good ESCR.

In one aspect the present invention relates to a mixed-plastic-polyethylene composition comprising
a total amount of ethylene units (C2 units) of from 90.00 to 99.00 wt.-%, preferably from 90.50 to 97.50 wt.-%, most preferably from 91.00 to 95.00 wt.-%,
a total amount of continuous units having 3 carbon atoms corresponding to polypropylene (continuous C3 units) of from 0.10 to 5.00 wt.-%, preferably from 0.20 to 2.50 wt.-%, most preferably from 0.50 to 1.50 wt.-%, and
a total combined amount of units having 4 carbon atoms (C4 units) and units having 6 carbon atoms (C6 units) of from 4.00 to 10.00 wt.-%, preferably from 4.25 wt.-% to 8.50 wt.-%, most preferably from 4.50 to 7.50 wt.-%,
   with the total amounts of C2 units, continuous C3 units, C4 units and C6 units being based on the total weight amount of monomer units in the composition and measured according to quantitative ¹³C{¹H} NMR measurement,
   and wherein the composition has
a melt flow rate (ISO 1133, 2.16 kg, 190° C.) of from 0.1 to 2.0 g/10 min, preferably from 0.2 to 1.7 g/10 min, most preferably from 0.3 to 1.5 g/10 min; and
a density of from 910 kg/m³ to 945 kg/m³, preferably from 912 to 943 kg/m³, most preferably from 915 to 942 kg/m³.

In another aspect the present invention relates to a mixed-plastic-polyethylene composition having
a melt flow rate (ISO 1133, 2.16 kg, 190° C.) of from 0.1 to 2.0 g/10 min, preferably from 0.2 to 1.7 g/10 min, most preferably from 0.3 to 1.5 g/10 min; and
a density of from 910 kg/m³ to 945 kg/m³, preferably from 912 to 943 kg/m³, most preferably from 915 to 942 kg/m³;
   obtainable by blending and extruding components comprising
   a) 25 to 85 wt.-%, based on the overall weight of the composition, of a mixed-plastic-polyethylene primary recycling blend (A)
   wherein at least 90 wt.-%, preferably at least 95 wt.-%, more preferably 100 wt.-% of the mixed-plastic-polyethylene primary blend (A) originates from post-consumer waste and/or post-industrial waste having a limonene content of from 0.1 to 500 mg/kg; and
   wherein the mixed-plastic-polyethylene primary blend (A) has
a melt flow rate (ISO 1133, 2.16 kg, 190° C.) of from 0.1 to 2.0 g/10 min, preferably from 0.3 to 1.5 g/10 min;
a density of from 910 to 945 kg/m³, preferably from 915 to 942 kg/m³, most preferably from 920 to 940 kg/m³; and
a total amount of ethylene units (C2 units) of from 80.00 to 96.00 wt.-%, preferably from 85.00 to 95.50 wt.-%, most preferably from 87.50 to 95.00 wt.-%, with the total amounts of C2 units being based on the total weight amount of monomer units in the mixed-plastic-polyethylene primary blend (A) and measured according to quantitative ¹³C{¹H} NMR measurement; and
   b) 15 to 75 wt.-%, based on the overall weight of the composition, of a secondary blend (B) of virgin linear low-density polyethylene (LLDPE), wherein the secondary blend (B) has
ethylene monomer units and comonomer units derived from olefins having from 3 to 6 carbon atoms,
a melt flow rate (ISO 1133, 2.16 kg, 190° C.) of from 0.10 to 1.5 g/10 min, preferably from 0.12 to 1.2 g/10 min, most preferably 0.15 to 1.0 g/10 min; and
a density of from 900 to <940 kg/m³, preferably from 910 to 939 kg/m³, most preferably from 915 to 937 kg/m³.

Further, the present invention relates to an article, comprising the mixed-plastic-polyethylene composition as described above or below, wherein the article preferably is a cable comprising at least one layer comprising the mixed-plastic-polyethylene composition as described above or below, wherein the article more preferably is a cable comprising a jacketing layer comprising the mixed-plastic-polyethylene composition as described above or below.

Still further, the present invention relates to a process for preparing the mixed-plastic-polyethylene composition as defined above or below, comprising the steps of:
a) providing a mixed-plastic-polyethylene primary recycling blend (A) in an amount of 25 to 85 wt.-% based on the overall weight of the composition, wherein at least 90 wt.-%, preferably at least 95 wt.-%, more preferably 100 wt.-% of the mixed-plastic-polyethylene primary blend (A) originates from post-consumer waste and/or post-industrial waste, wherein the mixed-plastic-polyethylene primary blend (A) has
   a melt flow rate (ISO 1133, 2.16 kg, 190° C.) of from 0.1 to 2.0 g/10 min, preferably from 0.3 to 1.5 g/10 min;
   a density of from 910 to 945 kg/m³, preferably from 915 to 942 kg/m³, most preferably from 920 to 940 kg/m³; and
   a total amount of ethylene units (C2 units) of from 80.00 to 96.00 wt.-%, preferably from 85.00 to 95.50 wt.-%, most preferably from 87.50 to 95.00 wt.-%, with the total amounts of C2 units being based on the total weight amount of monomer units in the mixed-plastic-polyethylene primary recycling blend (A) and measured according to quantitative ¹³C{¹H}NMR measurement;
b) providing a secondary blend (B) of virgin linear low-density polyethylene (LLDPE) in an amount of 15 to 75 wt.-% based on the overall weight of the composition, wherein the secondary blend (B) has
   ethylene monomer units and comonomer units derived from olefins having from 3 to 6 carbon atoms,
   a melt flow rate (ISO 1133, 2.16 kg, 190° C.) of from 0.10 to 1.5 g/10 min, preferably from 0.12 to 1.2 g/10 min, most preferably 0.15 to 1.0 g/10 min; and
   a density of from 900 to <940 kg/m³, preferably from 910 to 939 kg/m³, most preferably from 915 to 937 kg/m³;
c) melting and mixing the blend of the polyethylene blend (A) and the secondary blend (B) in an extruder, optionally a twin screw extruder, and
d) optionally pelletizing the obtained mixed-plastic-polyethylene composition.

Finally, the present invention relates to the use of a mixed-plastic-polyethylene composition as defined above or below for producing a cable layer, preferably a cable jacketing layer.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

For the purposes of the present description and of the subsequent claims, the term “recycled waste” is used to indicate a material recovered from post-consumer waste, as opposed to virgin polymers and/or materials. Post-consumer waste refers to objects having completed at least a first use cycle (or life cycle), i.e. having already served their first purpose.

The term “virgin” denotes the newly produced materials and/or objects prior to their first use, which have not already been recycled. The term “recycled material” such as used herein denotes materials reprocessed from “recycled waste”.

The term “natural” in the context of the present invention means that the accordant component is of natural colour. This means that no pigments (including carbon black) are included in the accordant component of the mixed-plastic-polyethylene composition of the present invention.

A blend denotes a mixture of two or more components, wherein one of the components is polymeric. In general, the blend can be prepared by mixing the two or more components. Suitable mixing procedures are known in the art. The term secondary blend (B) refers to a blend comprising at least 90 wt.-% of a reactor made linear low density polyethylene material. Said linear low density polyethylene material preferably does not contain carbon black or any other pigments. This linear low density polyethylene material is a virgin material which has not already been recycled.

The term “polyethylene blend” requires the presence of at least two different polyethylenes such as two polyethylenes differing as to their density. For example, a bimodal polyethylene as obtained from two reactors operated under different conditions constitutes a polyethylene blend, in this case an in-situ blend of two reactor products.

It is self explaining that polyethylene blends as obtained from consumer trash will include a broad variety of polyethylenes. In addition to that contamination by other plastics, mainly polypropylene, polystyrene, polyamide, polyesters, wood, paper, limonene, aldehydes, ketones, fatty acids, metals, and/or long term decomposition products of stabilizers can also be found. It goes without saying that such contaminants are not desirable.

It should be understood that the polyethylene blend of the present invention is not a cookie-cutter blend as some of the commercially available recyclates. The polyethylene blend according to the present invention should rather be compared with virgin blends.

For the purposes of the present description and of the subsequent claims, the term “mixed-plastic-polyethylene” indicates a polymer material including predominantly units derived from ethylene apart from other polymeric ingredients of arbitrary nature. Such polymeric ingredients may for example originate from monomer units derived from alpha olefins such as propylene, butylene, hexene, octene, and the like, styrene derivatives such as vinylstyrene, substituted and unsubstituted acrylates, substituted and unsubstituted methacrylates.

Said polymeric materials can be identified in the mixed-plastic polyethylene composition by means of quantitative ¹³C{¹H}NMR measurements as described herein. In the quantitative ¹³C{¹H}NMR measurement used herein and described below in the measurement methods different units in the polymeric chain can be distinguished and quantified. These units are ethylene units (C2 units), units having 3, 4 and 6 carbons and units having 7 carbon atoms.

Thereby, the units having 3 carbon atoms (C3 units) can be distinguished in the NMR spectrum as isolated C3 units (isolated C3 units) and as continuous C3 units (continuous C3 units) which indicate that the polymeric material contains a propylene based polymer. These continuous C3 units can also be identified as iPP units. The continuous C3 units thereby can be distinctively attributed to the mixed-plastic-polyethylene primary recycling blend (A) as the secondary blend (B) of virgin linear low density polyethylene (LLDPE) the mixed-plastic-polyethylene composition according to the present invention usually does not include any propylene based polymeric components.

The units having 3, 4, 6 and 7 carbon atoms describe units in the NMR spectrum which are derived from two carbon atoms in the main chain of the polymer and a short side chain or branch of 1 carbon atom (isolated C3 unit), 2 carbon atoms (C4 units), 4 carbon atoms (C6 units) or 5 carbon atoms (C7 units).

The units having 3, 4 and 6 carbon atoms (isolated C3, C4 and C6 units) can derive either from incorporated comomoners (propylene, 1-butene and 1-hexene comonomers) or from short chain branches formed by radical polymerization.

The units having 7 carbon atoms (C7 units) can be distinctively attributed to the mixed-plastic-polyethylene primary recycling blend (A) as they cannot derive from any comonomers. 1-heptene monomers are not used in copolymerization. Instead, the C7 units indicate presence of LDPE which is distinct for the recyclate. It has been found that in LDPE resins the amount of C7 units is always in a distinct range. Thus, the amount of C7 units measured by quantitative ¹³C{¹H}NMR measurements can be used to calculate the amount of LDPE in a polyethylene composition.

The amounts of continuous C3 units, isolated C3 units, C4 units, C6 units and C7 units are measured by quantitative ¹³C{¹H}NMR measurements as described below, whereas the LDPE content is calculated from the amount of C7 units as described below.

The total amount of ethylene units (C2 units) is attributed to units in the polymer chain, which do not have short side chains of 1-5 carbon atoms, in addition to the units attributed to the LDPE (i.e. units which have longer side chains branches of 6 or more carbon atoms).

A mixed-plastic-polyethylene primary blend (A) denotes the starting primary blend containing the mixed plastic-polyethylene as described above. Conventionally further components such as fillers, including organic and inorganic fillers for example talc, chalk, carbon black, and further pigments such as TiO₂ as well as paper and cellulose may be present. In a specific and preferred embodiment the waste stream is a consumer waste stream. Such a waste stream may originate from conventional collecting systems such as those implemented in the European Union. Post-consumer waste material is characterized by a limonene content of from 0.1 to 500 mg/kg (as determined using solid phase microextraction (HS-SPME-GC-MS) by standard addition).

Mixed-plastic-polyethylene primary blend(s) (A) as used herein are commercially available. One suitable recyclate is e.g. available from Ecoplast Kunststoffrecycling GmbH under the brand names NAV 101 and NAV 102.

Within the meaning of this invention the term “jacketing materials” refers to materials used in cable jacketing/cable coating applications for electrical/telephone/telecommunications cables. These materials are required to show good ESCR properties, such as a Bell test failure time of >1000 hours, preferably >3000 hours.

If not indicated otherwise “%” refers to weight-%.

### DETAILED DESCRIPTION

### Natural Mixed-Plastic-Polyethylene Primary Recycling Blend (A)

The mixed-plastic-polyethylene composition according to the present invention comprises a mixed-plastic-polyethylene primary recycling blend (A). It is the essence of the present invention that this primary recycling blend is obtained from a post-consumer waste stream and/or a post-industrial waste stream, preferably from a post-consumer waste stream.

According to the present invention the mixed-plastic-polyethylene primary recycling blend (A) is generally a blend, wherein at least 90 wt.-%, preferably at least 95 wt.-%, more preferably 100 wt.-% of the mixed-plastic-polyethylene primary recycling blend (A) originates from post-consumer waste, such as from conventional collecting systems (curb-side collection), such as those implemented in the European Union, and/or post-industrial waste.

Said post-consumer waste can be identified by its limonene content. It is preferred that the post-consumer waste has a limonene content of from 0.1 to 500 mg/kg.

The mixed-plastic-polyethylene primary recycling blend (A) preferably comprises
a total amount of ethylene units (C2 units) of from 80.00 wt.-% to 96.00 wt.-%, more preferably of from 82.50 wt.-% to 95.50 wt.-%, still more preferably of from 85.00 wt.-% to 95.50 wt.-% and most preferably of from 87.50 wt.-% to 95.00 wt.-%;
a total amount of continuous units having 3 carbon atoms corresponding to polypropylene (continuous C3 units) of from 0.20 to 6.50 wt.-%, more preferably from 0.40 wt.-% to 6.00 wt.-%, still more preferably from 0.60 wt.-% to 5.50 wt.-% and most preferably from 0.75 wt.-% to 5.00 wt.-%.

The total amounts of C2 units and continuous C3 units thereby are based on the total weight amount of monomer units in the mixed-plastic-polyethylene primary recycling blend (A) and are measured according to quantitative ¹³C{¹H}NMR measurement.

In addition to C2 units and continuous C3 units the mixed-plastic-polyethylene primary recycling blend (A) can further comprise units having 3, 4, 6 or 7 or more carbon atoms so that the mixed-plastic-polyethylene primary recycling blend (A) overall can comprise ethylene units and a mix of units having 3, 4, 6 and 7 or more carbon atoms.

The mixed-plastic-polyethylene primary recycling blend (A) preferably comprises one or more in any combination, preferably all of:
a total amount of units having 3 carbon atoms as isolated C3 units (isolated C3 units) of from 0 wt.-% to 0.50 wt.-%, more preferably from 0 wt.-% to 0.40 wt.-%, still more preferably from 0 wt.-% to 0.30 wt.-% and most preferably from 0 wt.-% to 0.25 wt.-%;
a total amount of units having 4 carbon atoms (C4 units) of from 0.50 to 5.00 wt.-%, more preferably from 0.75 wt.-% to 4.00 wt.-%, still more preferably from 1.00 wt.-% to 3.50 wt.-% and most preferably from 1.25 wt.-% to 3.00 wt.-%;
a total amount of units having 6 carbon atoms (C6 units) of from 0.50 to 7.50 wt.-%, more preferably from 0.75 wt.-% to 6.50 wt.-%, still more preferably from 1.00 wt.-% to 5.50 wt.-% and most preferably from 1.25 wt.-% to 5.00 wt.-%;
a total amount of units having 7 carbon atoms (C7 units) of from 0.30 wt.-% to 1.10 wt.-%, of from 0.35 wt.-% to 1.05 wt.-%, still more preferably of from 0.40 to 1.00 wt.-% and most preferably of from 0.45 wt.-% to 0.95 wt.-%, and
a LDPE content of from 20.00 to 70.00 wt.-%, more preferably from 25.00 wt.-% to 67.50 wt.-%, still more preferably from 27.50 wt.-% to 65.00 wt.-% and most preferably from 30.00 wt.-% to 62.50 wt.-%.

The total amounts of C2 units, continuous C3 units, isolated C3 units, C4 units, C6 units, C7 units and LDPE content thereby are based on the total weight amount of monomer units in the mixed-plastic-polyethylene primary recycling blend (A) and are measured or calculated according to quantitative ¹³C{¹H}NMR measurement.

Preferably, the total amount of units, which can be attributed to comonomers (i.e. isolated C3 units, C4 units and C6 units), in the mixed-plastic-polyethylene primary recycling blend (A) is from 3.00 wt.-% to 15.00 wt.-%, more preferably from 3.50 wt.-% to 12.50 wt.-%, still more preferably from 3.75 wt.-% to 10.00 wt.-% and most preferably from 4.00 wt.-% to 7.50 wt.-%, and is measured according to quantitative ¹³C{¹H}NMR measurement.

Additionally, the mixed-plastic-polyethylene primary recycling blend (A) preferably shows non-linear viscoelastic behaviour as shown in the below defined Large Oscillatory Shear (LAOS) measurement:

The mixed-plastic-polyethylene primary recycling blend (A) preferably has a Large Amplitude Oscillatory Shear Non Linear Factor at a strain of 1000%, LAOS_{NLF} (1000%), of from 2.200 to 10.000, more preferably from 2.400 to 8.500, still more preferably from 2.600 to 7.000 and most preferably from 2.800 to 5.000.

It is preferred that the mixed-plastic-polyethylene primary recycling blend (A) has
a melt flow rate (ISO 1133, 2.16 kg, 190° C.) of from 0.1 to 2.0 g/10 min, more preferably from 0.3 to 1.5 g/10 min; and/or
a density of from 910 to 945 kg/m³, more preferably from 915 to 942 kg/m³, most preferably from 920 to 940 kg/m³.

In one embodiment, the mixed-plastic-polyethylene primary recycling blend (A) does not comprise carbon black. In another embodiment, the mixed-plastic-polyethylene primary recycling blend (A) does also not comprise any pigments other than carbon black. In this case, the mixed-plastic-polyethylene primary recycling blend (A) may be a natural mixed-plastic-polyethylene primary recycling blend (A).

The mixed-plastic-polyethylene primary recycling blend (A) may also include:
a) 0 to 10 wt.-% units derived from alpha olefin(s),
b) 0 to 3.0 wt.-% stabilizers,
c) 0 to 3.0 wt.-% talc,
d) 0 to 3.0 wt.-% chalk,
e) 0 to 6.0 wt.-% further components
   wherein all percentages relate to the mixed-plastic-polyethylene primary recycling blend (A).

The mixed-plastic-polyethylene primary recycling blend (A) preferably has one or more, more preferably all, of the following properties in any combination:
a melt flow rate (ISO 1133, 5.0 kg, 190° C.) of from 1.5 to 5.0 g/10 min, more preferably from 1.8 to 4.0 g/10 min;
a melt flow rate (ISO 1133, 21.6 kg, 190° C.) of from 25.0 to 45.0 g/10 min, more preferably from 25.0 to 43.0 g/10 min;
a polydispersity index PI of from 1.0 to 3.5 s⁻¹, more preferably from 1.3 to 3.0 s⁻¹;
a shear thinning index SHI_{2.7/210} of from 15 to 45, more preferably from 20 to 43;
a complex viscosity at the frequency of 300 rad/s, eta₃₀₀, of from 500 to 750 Pa·s, more preferably from 550 to 700 Pa·s;
a complex viscosity at the frequency of 0.05 rad/s, eta_{0.05}, of from 15000 to 30000 Pa·s, more preferably from 15500 to 27500 Pa·s;
a Shore D hardness, measured after 15 s according to ISO 868, Shore D 15 s, of from 40 to 60, more preferably of from 45 to 55,
a Shore D hardness, measured after 1 s according to ISO 868, Shore D 1 s, of from 45 to 65, more preferably of from 48 to 60,
a Shore D hardness, measured after 3 s according to ISO 868, Shore D 3 s, of from 45 to 65, more preferably of from 48 to 60,
a Charpy notched impact strength at 23° C., Charpy NIS 23° C., of from 30 to 80 kJ/m², more preferably from 40 to 80 kJ/m²,
an ash content of from 0.01 to 2.5 wt.-%, more preferably of from 0.1 to 2.0 wt.-%, and/or
a limonene content of from 0.1 to 500 mg/kg.

It is preferred that the mixed-plastic-polyethylene primary recycling blend (A) has a comparatively low gel content, especially in comparison to other mixed-plastic-polyethylene primary recycling blends.

The mixed-plastic-polyethylene primary recycling blend (A) preferably has a gel content for gels with a size of from 600 μm to 999 μm of not more than 1000 gels/m², more preferably not more than 850 gels/m². The lower limit of the gel content for gels with a size of from 600 μm to 999 μm is usually 20 gels/m², preferably 40 gels/m².

Still further, the mixed-plastic polyethylene composition preferably has a gel content for gels with a size of from at least 1000 μm of not more than 200 gels/m², more preferably not more than 150 gels/m². The lower limit of the gel content for gels with a size of from at least 1000 μm is usually 2 gels/m², preferably 3 gels/m².

Generally, recycled materials perform less well in functional tests such as the ESCR (Bell test failure time), SH modulus and Shore D tests than virgin materials or blends comprising virgin materials.

The polyethylene blend (A) is preferably present in the composition of the present invention in an amount of from 25 to 85 wt.-%, more preferably 30 to 80 wt.-%, still more preferably from 35 to 75 wt.-%, even more preferably from 40 to 70 wt.-% and most preferably from 45 to 60 wt.-%, based on the overall weight of the composition.

### Secondary Blend (B) of Virgin Linear Low-Density Polyethylene (LLDPE)

The mixed-plastic-polyethylene composition of the invention comprises a secondary blend (B) of virgin linear low-density polyethylene (LLDPE).

The virgin linear low-density polyethylene (LLDPE) is preferably a commercially available LLDPE, which is suitable for cable jacketing applications.

The secondary blend (B) preferably has:
a melt flow rate (ISO 1133, 2.16 kg, 190° C.) of from 0.10 to 1.5 g/10 min, preferably from 0.12 to 1.2 g/10 min, most preferably 0.15 to 1.0 g/10 min; and/or
a density of from 900 to <940 kg/m³, preferably from 910 to 939 kg/m³, most preferably from 915 to 937 kg/m³.

The secondary blend (B) can comprise carbon black or other pigments in an amount of of not more than 5 wt.-%, preferably not more than 3 wt.-%.

The presence of carbon black has an influence on the density of the secondary blend (B). A secondary blend (B) comprising carbon black preferably has a density of from 910 to <940 kg/m³, more preferably from 920 to 939 kg/m³, most preferably from 925 to 937 kg/m³. In one embodiment the secondary blend (B) does not comprise carbon black. In another embodiment, the secondary blend (B) does also not comprise any pigments other than carbon black. In said embodiment, the secondary blend (B) of virgin linear low-density polyethylene (LLDPE) is a natural secondary blend (B) of virgin linear low-density polyethylene (LLDPE). The secondary blend (B) of virgin linear-density polyethylene (LLDPE) preferably has a density of from 900 to 935 kg/m³, preferably from 910 to 930 kg/m³, most preferably from 915 to 925 kg/m³.

The secondary blend (B) includes as polymeric component a copolymer of ethylene and one or more comonomer units selected from alpha-olefins having from 3 to 6 carbon atoms. It is preferred that the polymeric component is a copolymer of ethylene and 1-butene or a copolymer of ethylene and 1-hexene.

Apart from the polymeric component the secondary blend (B) can further comprise additives in an amount of 10 wt.0-% or below, more preferably 9 wt.-% or below, more preferably 7 wt.-% or below of the secondary blend (B). Suitable additives are usual additives for utilization with polyolefins, such as stabilizers (e.g. antioxidant agents), metal scavengers and/or UV-stabilizers, antistatic agents and utilization agents (such as processing aid agents).

The secondary blend (B) preferably has one or more, more preferably all of the following properties in any combination:
a shear thinning index SHI_{2.7/210} of from 25 to 45, more preferably from 30 to 40;
a complex viscosity at the frequency of 300 rad/s, eta₃₀₀, of from 500 to 900 Pa·s, more preferably from 550 to 700 Pa·s;
a complex viscosity at the frequency of 0.05 rad/s, eta_{0.05}, of from 12500 to 60000 Pa·s, more preferably from 15000 to 30000 Pa·s;
a Shore D hardness, measured after 15 s according to ISO 868, Shore D 15 s, of from 42 to 52, more preferably of from 45 to 50,
a Shore D hardness, measured after 1 s according to ISO 868, Shore D 1 s, of from 48 to 58, more preferably of from 50 to 56,
a Shore D hardness, measured after 3 s according to ISO 868, Shore D 3 s, of from 45 to 55, more preferably of from 47 to 53,
a strain hardening modulus, SH modulus, of from 12.5 to 35.0 MPa, more preferably from 15.0 to 25.0 MPa,
a Charpy notched impact strength at 23° C., Charpy NIS 23° C., of from 50.0 to 100.0 kJ/m², more preferably from 70.0 to 85.0 kJ/m²,
a Charpy notched impact strength at 0° C., Charpy NIS 0° C., of from 70.0 to 125.0 kJ/m², more preferably from 85.0 to 110.0 kJ/m²,
a flexural modulus of from 350 to 500 MPa, more preferably from 375 to 450 MPa,
a tensile stress at break of from 15 to 40 MPa, more preferably from 20 to 30 MPa,
a tensile strain at break of from 600 to 900%, more preferably from 700 to 850%,
an environmental stress crack resistance, ESCR, of at least 2500 hours, more preferably at least 3000 hours, and/or
a limonene content of less than 0.1 mg/kg.

Generally, recycled materials perform less well in functional tests such as the ESCR (Bell test failure time), SH modulus and Shore D tests than virgin materials or blends comprising virgin materials.

The secondary blend (B) is preferably present in the composition of the present invention in an amount of from 15 to 75 wt.-%, more preferably from 20 to 70 wt.-%, still more preferably from 25 to 65 wt.-%, even more preferably from 30 to 60 wt.-% and most preferably from 33 to 55 wt.-%, based on the overall weight of the composition.

### Component (C) of Virgin Very Low-Density Polyethylene (VLDPE)

In one specific embodiment the mixed-plastic-polyethylene composition of the invention additionally comprises a component (C) of virgin very low-density polyethylene (VLDPE). The very low-density polyethylene (VLDPE) can be identified as elastomer. According to the IUPAC definition an elastomer is a polymer that displays rubber-like elasticity. Polyethylene based elastomers are commercially available under the tradenames Queo™ Exact™, Engage™ and others.

The component (C) preferably has:
a melt flow rate (ISO 1133, 2.16 kg, 190° C.) of from 0.1 to 1.5 g/10 min, preferably from 0.2 to 1.2 g/10 min, most preferably from 0.3 to 1.0 g/10 min; and/or
a density of from 840 to <900 kg/m³, preferably from 850 to 890 kg/m³, most preferably from 860 to 875 kg/m³.

In one embodiment the component (C) does not comprise carbon black. In another embodiment the component (C) does also not comprise any pigments other than carbon black. In said embodiment the component (C) of virgin very low-density polyethylene (VLDPE) is a natural component (C) of virgin very low-density polyethylene (VLDPE).

The natural component (C) of virgin very low-density polyethylene (VLDPE) preferably has a density of from 840 to <900 kg/m³, preferably from 850 to 890 kg/m³, most preferably from 860 to 875 kg/m³.

The component (C) includes as polymeric component a copolymer of ethylene and one or more comonomer units selected from alpha-olefins having from 3 to 12 carbon atoms. It is preferred that the polymeric component is a copolymer of ethylene and 1-butene or a copolymer of ethylene and 1-octene, most preferably a copolymer of ethylene and 1-octene. The polymeric component of the component (C) is preferably produced in a solution polymerization process using a metallocene catalyst, as known in the art.

Apart from the polymeric component the component (C) can further comprise additives in an amount of 10 wt.-% or below, more preferably 9 wt.-% or below, more preferably 7 wt.-% or below of the component (C). Suitable additives are usual additives for utilization with polyolefins, such as stabilizers (e.g. antioxidant agents), metal scavengers and/or UV-stabilizers, antistatic agents and utilization agents (such as processing aid agents). It is preferred that the component (C) consists of said polymeric component and the optional additives.

The component (C) preferably has one or more, more preferably all of the following properties in any combination:
a melting temperature, Tm, of from 40 to 60° C., more preferably from 45 to 55° C.;
a glass transition temperature, Tg, of from −65° C. to −45°, preferably from −60° C. to −50° C.;
a flexural modulus of from 2.5 MPa to 15.0 MPa, more preferably from 5.0 MPa to 12.0 MPa;
a tensile stress at break of from 2.0 to 15.0 MPa, more preferably from 4.0 to 10.0 MPa,
a tensile strain at break of from 200 to 500% more preferably from 300 to 450%,
a Shore D hardness, measured after 1 s according to ISO 868, Shore D 1 s, of from 10 to 30, more preferably from 15 to 25; and/or
a limonene content of less than 0.1 mg/kg.

If present, the component of virgin very low-density polyethylene (VLDPE) is preferably present in the composition of the present invention in an amount of from 1 to 20 wt.-%, more preferably from 2 to 18 wt.-%, still more preferably from 3 to 17 wt.-%, even more preferably from 4 to 16 wt.-% and most preferably from 5 to 15 wt.-%, based on the overall weight of the composition.

### Mixed-Plastic-Polyethylene Composition

The present invention seeks to provide a mixed-plastic-polyethylene composition comprising a mixed-plastic-polyethylene primary recycling blend (A), preferably from post-consumer waste or post-industrial waste, with a beneficial balance of ESCR, impact strength and flexural modulus compared to the mixed-plastic-polyethylene primary recycling blend (A), to levels which are suitable for jacketing applications.

The mixed-plastic-polyethylene composition as described herein is especially suitable for wire and cable applications, such as jacketing applications.

In a first aspect the present invention relates to a mixed-plastic-polyethylene composition comprising
a total amount of ethylene units (C2 units) of from 90.00 to 99.00 wt.-%, preferably from 90.50 to 97.50 wt.-%, most preferably from 91.00 to 95.00 wt.-%,
a total amount of continuous units having 3 carbon atoms corresponding to polypropylene (continuous C3 units) of from 0.10 to 5.00 wt.-%, preferably from 0.20 to 2.50 wt.-%, most preferably from 0.50 to 1.50 wt.-%, and
a total combined amount of units having 4 carbon atoms (C4 units) and units having 6 carbon atoms (C6 units) of from 4.00 to 10.00 wt.-%, preferably from 4.25 wt.-% to 8.50 wt.-%, most preferably from 4.50 to 7.50 wt.-%,
   with the total amounts of C2 units, continuous C3 units, C4 units and C6 units being based on the total weight amount of monomer units in the composition and measured according to quantitative ¹³C{¹H}NMR measurement,
   and wherein the composition has
a melt flow rate (ISO 1133, 2.16 kg, 190° C.) of from 0.1 to 2.0 g/10 min, preferably from 0.2 to 1.7 g/10 min, most preferably from 0.3 to 1.5 g/10 min; and
a density of from 910 kg/m³ to 945 kg/m³, preferably from 912 to 943 kg/m³, most preferably from 915 to 942 kg/m³.

In said aspect the mixed-plastic-polyethylene composition is preferably obtainable by blending and extruding components comprising
a) 25 to 85 wt.-%, based on the overall weight of the composition, of a mixed-plastic-polyethylene primary recycling blend (A)
   wherein at least 90 wt.-%, preferably at least 95 wt.-%, more preferably 100 wt.-% of the mixed-plastic-polyethylene primary blend (A) originates from post-consumer waste and/or post-industrial waste having a limonene content of from 0.1 to 500 mg/kg; and
   wherein the mixed-plastic-polyethylene primary blend (A) has
      a melt flow rate (ISO 1133, 2.16 kg, 190° C.) of from 0.1 to 1.2 g/10 min, preferably from 0.3 to 1.1 g/10 min;
      a density of from 910 to 945 kg/m³, preferably from 915 to 942 kg/m³, most preferably from 920 to 940 kg/m³; and
      a total amount of ethylene units (C2 units) of from 80.00 to 96.00 wt.-%, with the total amount of C2 units being based on the total weight amount of monomer units in the mixed-plastic-polyethylene primary blend (A) and measured according to quantitative ¹³C{¹H}NMR measurement; and
b) 15 to 75 wt.-%, based on the overall weight of the composition, of a secondary blend (B) of virgin linear low-density polyethylene (LLDPE), wherein the secondary blend (B) has
   ethylene monomer units and comonomer units derived from olefins having from 3 to 6 carbon atoms,
   a melt flow rate (ISO 1133, 2.16 kg, 190° C.) of from 0.10 to 1.5 g/10 min, preferably from 0.12 to 1.2 g/10 min, most preferably 0.15 to 1.0 g/10 min; and
   a density of from 900 to <940 kg/m³, preferably from 910 to 939 kg/m³, most preferably from 915 to 937 kg/m³.

In one embodiment the mixed-plastic-polyethylene composition only comprises, preferably consists of the mixed-plastic-polyethylene primary recycling blend (A) and the secondary blend (B) of virgin linear low density polyethylene (LLDPE) as polymeric components.

In another embodiment the mixed-plastic polyethylene composition comprises, preferably consists of the mixed-plastic-polyethylene primary recycling blend (A), the secondary blend (B) of virgin linear low density polyethylene (LLDPE) and a component (C) of virgin very low density polyethylene (VLDPE) as polymeric components.

In said embodiment the mixed-plastic polyethylene composition is obtainable by blending and extruding components comprising
a) 25 to 84 wt.-%, based on the overall weight of the composition, of the mixed-plastic-polyethylene primary recycling blend (A);
b) 15 to 65 wt.-%, based on the overall weight of the composition, of the secondary blend (B) of virgin linear low-density polyethylene (LLDPE); and
c) 1 to 20 wt.-%, based on the overall weight of the composition, of a component (C) of virgin very low-density polyethylene (VLDPE), the blend (C) having
   ethylene monomer units and comonomer units derived from olefins having from 3 to 12 carbon atoms,
   a melt flow rate (ISO 1133, 2.16 kg, 190° C.) of from 0.1 to 1.5 g/10 min, preferably from 0.2 to 1.2 g/10 min, most preferably from 0.3 to 1.0 g/10 min, and
   a density of from 840 to <900 kg/m³, preferably from 850 to 890 kg/m³, most preferably from 860 to 875 kg/m³.

In a second aspect the present invention relates to a mixed-plastic-polyethylene composition having
a melt flow rate (ISO 1133, 2.16 kg, 190° C.) of from 0.1 to 2.0 g/10 min, preferably from 0.2 to 1.7 g/10 min, most preferably from 0.3 to 1.5 g/10 min; and
a density of from 910 kg/m³ to 945 kg/m³, preferably from 912 to 943 kg/m³, most preferably from 915 to 942 kg/m³;
   obtainable by blending and extruding components comprising
a) 25 to 85 wt.-%, based on the overall weight of the composition, of a mixed-plastic-polyethylene primary recycling blend (A), wherein at least 90 wt.-%, preferably at least 95 wt.-%, more preferably 100 wt.-% of the mixed-plastic-polyethylene primary blend (A) originates from post-consumer waste and/or post-industrial waste having a limonene content of from 0.1 to 500 mg/kg; and wherein the mixed-plastic-polyethylene primary blend (A) has
   a melt flow rate (ISO 1133, 2.16 kg, 190° C.) of from 0.1 to 2.0 g/10 min, preferably from 0.3 to 1.5 g/10 min;
   a density of from 910 to 945 kg/m³, preferably from 915 to 942 kg/m³, most preferably from 920 to 940 kg/m³; and
   a total amount of ethylene units (C2 units) of from 80.00 to 96.00 wt.-%, with the total amounts of C2 units being based on the total weight amount of monomer units in the mixed-plastic-polyethylene primary blend (A) and measured according to quantitative ¹³C{¹H}NMR measurement;
and
a) 15 to 75 wt.-%, based on the overall weight of the composition, of a secondary blend (B) of virgin linear low-density polyethylene (LLDPE), wherein the secondary blend (B) has
   ethylene monomer units and comonomer units derived from olefins having from 3 to 6 carbon atoms,
   a melt flow rate (ISO 1133, 2.16 kg, 190° C.) of from 0.10 to 1.5 g/10 min, preferably from 0.12 to 1.2 g/10 min, most preferably 0.15 to 1.0 g/10 min; and
   a density of from 900 to <940 kg/m³, preferably from 910 to 939 kg/m³, most preferably from 915 to 937 kg/m³.

The mixed-plastic-polyethylene composition preferably has a flexural modulus of from 250 to 500 MPa, preferably from 260 to 480 MPa, most preferably from 280 to 460 MPa.

In one embodiment the mixed-plastic-polyethylene composition only comprises, preferably consists of the polyethylene blend (A) and the secondary blend (B) of virgin linear low-density polyethylene (LLDPE) as polymeric components.

The weight ratio of the polyethylene blend (A) and the secondary blend (B) of virgin linear low-density polyethylene (LLDPE) is preferably in the range of from 25:75 to 85:15, more preferably from 30:70 to 80:20, still more preferably from 35:65 to 75:25, even more preferably from 40:60 to 70:30, and most preferably from 45:55 to 60:40.

In said embodiment the mixed-plastic-polyethylene composition preferably has a flexural modulus of from 350 to 500 MPa, preferably from 375 to 480 MPa, most preferably from 390 to 460 MPa.

In another embodiment the mixed-plastic polyethylene composition comprises, preferably consists of the polyethylene blend (A), the secondary blend (B) of virgin linear low-density polyethylene (LLDPE) and a component (C) of virgin very low-density polyethylene (VLDPE) as polymeric components.

In said embodiment the mixed-plastic polyethylene composition is obtainable by blending and extruding components comprising
25 to 84 wt.-%, based on the overall weight of the composition, of the mixed-plastic-polyethylene primary recycling blend (A);
15 to 65 wt.-%, based on the overall weight of the composition, of the secondary blend (B) of virgin linear low-density polyethylene (LLDPE); and
1 to 20 wt.-%, based on the overall weight of the composition, of a component (C) of virgin very low-density polyethylene (VLDPE), the blend (C) having
ethylene monomer units and comonomer units derived from olefins having from 3 to 12 carbon atoms,
a melt flow rate (ISO 1133, 5 kg, 190° C.) of from 0.1 to 1.5 g/10 min, preferably from 0.2 to 1.2 g/10 min, most preferably from 0.3 to 1.0 g/10 min, and
a density of from 840 to <900 kg/m³, preferably from 850 to 890 kg/m³, most preferably from 860 to 875 kg/m³.

It is preferred that in said embodiment the mixed-plastic polyethylene composition comprises, preferably consists of the polyethylene blend (A), the secondary blend (B) of virgin linear low-density polyethylene (LLDPE) and a component (C) of virgin very low-density polyethylene (VLDPE) as polymeric components.

The weight ratio of polyethylene blend (A) and the combined blend of the secondary blend (B) of virgin linear low-density polyethylene (LLDPE) and the component (C) of virgin very low-density polyethylene (VLDPE) is preferably in the range of from 25:75 to 84:16, more preferably from 30:70 to 80:20, still more preferably from 35:65 to 75:25, even more preferably from 40:60 to 70:30, and most preferably from 45:55 to 60:40.

In said embodiment the mixed-plastic-polyethylene composition preferably has a flexural modulus of from 250 to 400 MPa, preferably from 260 to 375 MPa, most preferably from 280 to 365 MPa.

The following properties apply to all embodiments of the mixed-plastic polyethylene composition:

The mixed-plastic-polyethylene composition preferably comprises one or more in any combination of, more preferably all of:
a total amount of ethylene units (C2 units) of from 90.00 to 99.00 wt.-%, preferably from 90.50 to 97.50 wt.-%, most preferably from 91.00 to 95.00 wt.-%,
a total amount of continuous units having 3 carbon atoms corresponding to polypropylene (continuous C3 units) of from 0.10 to 5.00 wt.-%, preferably from 0.20 to 2.50 wt.-%, most preferably from 0.50 to 1.50 wt.-%,
a total amount of units having 3 carbon atoms as isolated peaks in the NMR spectrum (isolated C3 units) of from 0 wt.-% to 0.50 wt.-%, more preferably from 0 wt.-% to 0.40 wt.-%, still more preferably from 0 wt.-% to 0.30 wt.-%;
a total amount of units having 4 carbon atoms (C4 units) of from 0.50 wt.-% to 8.00 wt.-%, more preferably from 1.00 wt.-% to 7.00 wt.-%, still more preferably from 2.00 wt.-% to 6.00 wt.-%;
a total amount of units having 6 carbon atoms (C6 units) of from 0.30 wt.-% to 6.00 wt.-%, more preferably from 0.50 wt.-% to 5.00 wt.-%, still more preferably from 0.75 wt.-% to 3.50 wt.-%;
a total combined amount of units having 4 carbon atoms (C4 units) and units having 6 carbon atoms (C6 units) of from 4.00 to 10.00 wt.-%, preferably from 4.25 wt.-% to 8.50 wt.-%, most preferably from 4.50 to 7.50 wt.-%;
a total amount of units having 7 carbon atoms (C7 units) of from 0 wt.-% to 1.00 wt.-%, more preferably from 0 wt.-% to 0.85 wt.-%, still more preferably from 0 wt.-% to 0.75 wt.-%;
a LDPE content of from 7.50 to 50.00 wt.-%, more preferably from 10.00 wt.-% to 45.00 wt.-%, still more preferably from 11.50 wt.-% to 42.50 wt.-% and most preferably from 12.50 wt.-% to 40.00 wt.-%,

The total amounts of C2 units, continuous C3 units, isolated C3 units, C4 units, C6 units, C7 units and LDPE content thereby are based on the total weight amount of monomer units in the composition and are measured or calculated according to quantitative ¹³C{¹H}NMR measurement.

Preferably, the total amounts of units, which can be attributed to comonomers (i.e. isolated C3 units, C4 units and C6 units), in the mixed-plastic-polyethylene composition is from 4.00 wt.-% to 10.00 wt.-%, more preferably from 4.25 wt.-% to 8.50 wt.-%, still more preferably from 4.50 wt.-% to 7.50 wt.-%, and is measured according to quantitative ¹³C{¹H}NMR measurement.

The mixed-plastic polyethylene composition according to the present invention has a
a melt flow rate (ISO 1133, 2.16 kg, 190° C.) of from 0.1 to 2.0 g/10 min, preferably from 0.2 to 1.7 g/10 min, most preferably from 0.3 to 1.5 g/10 min; and
a density of from 910 kg/m³ to 945 kg/m³, preferably from 912 to 943 kg/m³, most preferably from 915 to 942 kg/m³.

Additionally, the mixed-plastic polyethylene composition preferably shows non-linear viscoelastic behaviour as shown in the below defined Large Oscillatory Shear (LAOS) measurement:

The mixed-plastic polyethylene composition preferably has a Large Amplitude Oscillatory Shear Non Linear Factor at a strain of 1000%, LAOS_{NLF} (1000%), of from 2.000 to 4.000, more preferably from 2.100 to 3.500, still more preferably from 2.000 to 3.000 and most preferably from 2.250 to 2.750.

The mixed-plastic polyethylene composition preferably has a Charpy Notched Impact Strength at 23° C. of from 65 to 100 kJ/m², preferably from 65 to 95 kJ/m², most preferably from 70 to 85 kJ/m².

Further, the mixed-plastic polyethylene composition preferably has a Charpy Notched Impact Strength at 0° C. of from 20 to 120 kJ/m², preferably from 35 to 110 kJ/m², most preferably from 60 to 100 kJ/m².

The mixed-plastic polyethylene composition preferably has a strain hardening modulus (SH modulus) of from 7.5 to 25.0 MPa, more preferably from 8.5 to 24.0 MPa and most preferably from 10.0 to 22.5 MPa.

Further, the mixed-plastic polyethylene composition preferably has an ESCR (Bell test failure time) of more than 2500 hours, preferably at least 3000 hours and still more preferably at least 4000 hours and most preferably at least 5000 hours. The upper limit of the ESCR can be as high as 30000 hours, usually up to 20000 hours.

It is further preferred that that the mixed-plastic polyethylene composition preferably has
a Shore D hardness, measured according to ISO 868 with a measuring time of 1 s, Shore D Is, of from 42.0 to 60.0, preferably from 44.0 to 58.0, most preferably from 46.0 to 55.0, and/or
a Shore D hardness, measured according to ISO 868 with a measuring time of 3 s, Shore D 3s, of from 38.0 to 58.0, preferably from 40.0 to 55.0, most preferably from 42.0 to 53.0, and/or
a Shore D hardness, measured according to ISO 868 with a measuring time of 15 s, Shore D 15 s, of from 35.0 to 55.0, preferably from 38.0 to 53.0, most preferably from 40.0 to 50.0.

The mixed-plastic polyethylene composition preferably has one or more, preferably all of the following rheological properties, in any combination:
a shear thinning index SHI_{(2.7/210)} of from 18 to 60, preferably from 20 to 55, most preferably from 22 to 50; and/or
a complex viscosity at 0.05 rad/s eta_{0.05} rad/s of from 10000 to 45000 Pa·s, preferably from 12000 to 42500 Pa·s, most preferably from 14000 to 40000 Pa·s, and/or
a complex viscosity at 300 rad/s eta₃₀₀ rad/s of from 500 to 900 Pa·s, preferably from 550 to 850 Pa·s, most preferably from 575 to 800 Pa·s, and/or
a polydispersity index PI of from 1.0 to 4.0 s⁻¹, preferably from 1.2 to 3.5 s⁻¹, most preferably from 1.5 to 3.2 s⁻¹.

Further, the mixed-plastic polyethylene composition preferably has one or more, preferably all of the following melt flow rate properties, in any combination:
a melt flow rate (ISO 1133, 2.16 kg, 190° C.) of from 0.1 to 2.0 g/10 min, preferably from 0.2 to 1.7 g/10 min, most preferably from 0.3 to 1.5 g/10 min, and/or
a melt flow rate (ISO 1133, 5 kg, 190° C.) of from 1.0 to 5.0 g/10 min, preferably from 1.1 to 4.5 g/10 min, most preferably from 1.2 to 4.0 g/10 min, and/or
a melt flow rate (ISO 1133, 21.6 kg, 190° C.) of from 15 to 70 g/10 min, preferably from 17 to 65 g/10 min, most preferably from 20 to 60 g/10 min.

Still further, the mixed-plastic polyethylene composition may have one or more, preferably all of the following tensile properties, in any combination:
a tensile strain at break, measured according to ISO 527-2 on compression moulded test specimens of type 5A, of from 650% to 900%, more preferably from 700% to 850%; and/or
a tensile stress at break, measured according to ISO 527-2 on compression moulded test specimens of type 5A, of from 18 MPa to 35 MPa, more preferably from 20 MPa to 30 MPa.

It is further preferred that the mixed-plastic polyethylene composition has a pressure deformation of not more than 42%, preferably not more than 38%, most preferably not more than 35%. The lower limit is usually at least 5%, preferably at least 10%.

Still further, the mixed-plastic polyethylene composition preferably has a water content of preferably not more than 350 ppm, preferably not more than 330 ppm, most preferably not more than 320 ppm. The lower limit is usually at least 15 ppm, preferably at least 25 ppm.

The composition can have further components apart from the mixed-plastic-polyethylene primary recycling blend (A) and the secondary blend (B) of virgin linear low-density polyethylene (LLDPE), and the optional component (C) of virgin very low-density polyethylene (VLDPE), such as further polymeric components or additives in amounts of not more than 15 wt.-%, based on the total weight of the composition.

Suitable additives are usual additives for utilization with polyolefins, such as stabilizers, (e.g. antioxidant agents), metal scavengers and/or UV stabilizers, antistatic agents, and utilization agents. The additives can be present in the composition in an amount of 10 wt.-% or below, more preferably 9 wt.-% or below, more preferably 7 wt.-% or below.

Carbon black or other pigments are not enclosed in the definition of additives.

In one embodiment the composition comprises carbon black or pigments, preferably carbon black in an amount of not more than 5 wt.-%, preferably not more than 3 wt.-%. The lower limit of carbon black in said embodiment is usually at least 1.0 wt.-%, preferably at least 2.0 wt.-%.

In one embodiment the composition does not contain carbon black. In another embodiment, the composition also does not contain any pigments other than carbon black. In said embodiment, the mixed-plastic-polyethylene composition is a natural mixed-plastic-polyethylene composition.

It is, however, preferred that the composition consists of the mixed-plastic-polyethylene primary recycling blend (A) and the secondary blend (B) of virgin linear low density polyethylene (LLDPE), the optional component (C) of virgin very low density polyethylene (VLDPE), optional pigments or carbon black and optional additives.

The presence of carbon black has an influence on the density of the composition. A composition comprising carbon black preferably has a density of from 920 kg/m³ to 945 kg/m³, preferably from 924 to 943 kg/m³, most preferably from 927 to 942 kg/m³. A composition free from carbon black preferably has a density of from 910 kg/m³ to 935 kg/m³, preferably from 912 to 933 kg/m³, most preferably from 915 to 930 kg/m³.

The polyethylene blend (A), the secondary blend (B) of virgin linear low-density polyethylene (LLDPE) and the component (C) of virgin very low-density polyethylene (VLDPE) are generally defined as described above or below.

One positive aspect of the present invention of said embodiment is that although rather high amounts of polyethylene blend (A) can be used, the composition still shows acceptable properties especially in regard of ESCR and Charpy Notched Impact Strength. It has been found that the addition of the component (C) of virgin very low-density polyethylene (VLDPE) to the composition in small amounts thereby especially improves the flexibility in form of a lower flexural modulus without sacrificing the impact and tensile properties.

### Article

The present application is further directed to an article comprising the mixed-plastic-polyethylene composition as described above.

In a preferred embodiment, the article is used in jacketing applications i.e. for a cable jacket. Preferably the article is a cable comprising at least one layer which comprises the mixed-plastic-polyethylene composition as described above.

Preferably, the cable comprising a layer such as a jacketing layer, which comprises the mixed-plastic-polyethylene composition as described above, has a cable shrinkage of not more than 1.5%, preferably not more than 1.0%, most preferably not more than 0.8%. The lower limit is usually at least 0.1%, preferably at least 0.2%.

Further, the cable comprising a layer such as a jacketing layer, which comprises the mixed-plastic-polyethylene composition as described above, preferably has the following tensile properties:
a tensile strain at break, measured according to EN60811-501 on cable specimen, of from 400% to 700%, more preferably from 425% to 650%, most preferably 450 to 600%; and/or
a tensile stress at break, measured according to EN60811-501 on cable specimen, of from 12 to 30 MPa, preferably from 14 to 27 MPa, most preferably from 16 MPa to 25 MPa.

All preferred aspects and embodiments as described above shall also hold for the article.

### Process

The present invention also relates to a process for preparing the mixed-plastic-polyethylene composition as defined above or below. The process according to the present invention results in an improvement in the mechanical properties of the mixed-plastic-polyethylene primary recycling blend (A).

The process according to the present invention comprises the steps of:
a) providing a mixed-plastic-polyethylene primary recycling blend (A) in an amount of 25 to 85 wt.-% based on the overall weight of the composition,
   wherein at least 90 wt.-%, preferably at least 95 wt.-%, more preferably 100 wt.-% of the mixed-plastic-polyethylene primary blend (A) originates from post-consumer waste and/or post-industrial waste wherein the mixed-plastic-polyethylene primary blend (A) has
      a melt flow rate (ISO 1133, 2.16 kg, 190° C.) of from 0.1 to 2.0 g/10 min, preferably from 0.3 to 1.5 g/10 min;
      a density of from 910 to 945 kg/m³, preferably from 915 to 942 kg/m³, most preferably from 920 to 940 kg/m³; and
      a total amount of ethylene units (C2 units) of from 80.00 to 96.00 wt.-%,
      with the total amount of C2 units being based on the total weight amount of monomer units in the mixed-plastic-polyethylene primary blend (A) and measured according to quantitative ¹³C{¹H}NMR measurement;
b) providing a secondary blend (B) of virgin linear low-density polyethylene (LDPE) in an amount of 15 to 75 wt.-% based on the overall weight of the composition, wherein the secondary blend (B) has
   ethylene monomer units and comonomer units derived from olefins having from 3 to 6 carbon atoms,
   a melt flow rate (ISO 1133, 2.16 kg, 190° C.) of from 0.10 to 1.5 g/10 min, preferably from 0.12 to 1.2 g/10 min, most preferably 0.15 to 1.0 g/10 min; and
   a density of from 900 to <940 kg/m³, preferably from 910 to 939 kg/m³, most preferably from 915 to 937 kg/m³;
c) melting and mixing the blend of the polyethylene blend (A) and the secondary blend (B) in an extruder, optionally a twin screw extruder, and
d) optionally pelletizing the obtained mixed-plastic-polyethylene composition.

In one embodiment the process of the invention as described above comprises the steps of:
a) providing the polyethylene blend (A) in an amount of 25 to 84 wt.-% based on the overall weight of the composition;
b) providing the secondary blend (B) of virgin linear low-density polyethylene (LLDPE) in an amount of 15 to 80 wt.-% based on the overall weight of the composition;
c) providing a component (C) of virgin very low-density polyethylene (VLDPE) in an amount of 1 to 20 wt.-% based on the overall weight of the composition, wherein the component (C) has
   ethylene monomer units and comonomer units derived from olefins having from 3 to 12 carbon atoms,
   a melt flow rate (ISO 1133, 5 kg, 190° C.) of from 0.1 to 1.5 g/10 min, preferably from 0.2 to 1.2 g/10 min, most preferably from 0.3 to 1.0 g/10 min, and
   a density of from 840 to <900 kg/m³, preferably from 850 to 890 kg/m³, most preferably from 860 to 875 kg/m³,
d) melting and mixing the blend of polyethylene blend (A), the secondary blend (B) and the component (C) in an extruder, optionally a twin screw extruder, and
e) optionally pelletizing the obtained mixed-plastic-polyethylene composition.

All preferred aspects, definitions and embodiments as described above shall also hold for the process.

### Use

The present invention relates to the use of a mixed-plastic-polyethylene composition as defined above or below for producing a cable layer, preferably a cable jacketing layer.

All preferred aspects, definitions and embodiments as described above shall also hold for the use.

### EXAMPLES

### 1. Test Methods

### a) Melt Flow Rate

Melt flow rates were measured with a load of 2.16 kg (MFR₂), 5.0 kg (MFR₅) or 21.6 kg (MFR₂1) at 190° C. as indicated. The melt flow rate is that quantity of polymer in grams which the test apparatus standardized to ISO 1133 extrudes within 10 minutes at a temperature of or 190° C. under a load of 2.16 kg, 5.0 kg or 21.6 kg.

### b) Density

Density is measured according to ISO 1183-187. Sample preparation is done by compression moulding in accordance with ISO 17855-2.

### c) Comonomer Content

### Quantification of C2, iPP (Continuous C3), LDPE and Polyethylene Short Chain Branches in Polyethylene Based Recylates

Quantitative ¹³C{¹H}NMR spectra were recorded in the solution-state using a Bruker AvanceIII 400 MHz NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {zhou07,busico07}. A total of 6144 (6 k) transients were acquired per spectra.

Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3 s 32.2 ppm) were observed. The intensity of the combined ethylene backbone methine carbons (ddg) containing the polyethylene backbone carbons (dd 30.0 ppm), γ-carbons (g 29.6 ppm) the 4 s and the threeB4 carbon (to be compensated for later on) is taken between 30.9 ppm and 29.3 ppm excluding the Too from polypropylene. The amount of C2 related carbons was quantified using all mentioned signals according to the following equation:

$${fC}_{C 2 total} = ( Iddg - ItwoB 4 ) + ( IstarB 1 ⋆ 6 ) + ( I s tarB 2 ⋆ 7 ) + ( I twoB 4 ⋆ 9 ) + I ( t h reeB 5 ⋆ 10 ) + ( ( Ist arB 4 plus - I t woB 4 IthreeB 5 ) ⋆ 7 ) + ( I 3 s ⋆ 3 )$$

Characteristic signals corresponding to the presence of polypropylene (iPP, continuous C3)) were observed at 46.7 ppm, 29.0 ppm and 22.0 ppm. The amount of PP related carbons was quantified using the integral of Sαα at 46.6 ppm:

$${fC}_{PP} = Is αα ⋆ 3$$

The weight percent of the C2 fraction and the polypropylene can be quantified according following equations:

$${wt}_{C 2 fraction} = {fC}_{C 2 total} ⋆ 100 / ( {fC}_{C 2 total} + {fC}_{PP} )$$

$${wt}_{PP} = {fC}_{PP} ⋆ 100 / ( {fC}_{C 2 total} + {fC}_{PP} )$$

Characteristic signals corresponding to various short chain branches were observed and their weight percentages quantified as the related branch would be an alpha-olefin, starting by quantifying the weight fraction of each:

$$f wt C 2 = {fC}_{C 2 total} - ( ( IstarB 1 ⋆ 3 ) - ( IstarB 2 ⋆ 4 ) - ( ItwoB 4 ⋆ 6 ) - ( IthreeB 5 ⋆ 7 )$$

$$f wt C 3 ( isolated C 3 ) = IstarB 1 ⋆ 3$$

$$f wt C 4 = IstarB 2 ⋆ 4$$

$$f wt C 6 = ItwoB 4 ⋆ 6$$

$$f wt C 7 = IthreeB 5 ⋆ 7$$

Normalisation of all weight fractions leads to the amount of weight percent for all related branches:

$${fsum}_{wt . - \% total} = f wt C 2 + f wt C 3 + f wt C 4 + f wt C 6 + f wt C 7 + {fC}_{PP}$$

$$wt C 2 total = f wt C 2 ⋆ 100 / {fsum}_{wt . - \% total}$$

$$wt C 3 total = f wt C 3 ⋆ 100 / {fsum}_{wt . - \% total}$$

$$wt C 4 total = f wt C 4 ⋆ 100 / {fsum}_{wt . - \% total}$$

$$wt C 6 total = f wt C 6 ⋆ 100 / {fsum}_{wt . - \% total}$$

$$wt C 7 total = f wt C 7 ⋆ 100 / {fsum}_{wt . - \% total}$$

The content of LDPE can be estimated assuming the B5 branch, which only arises from ethylene being polymerized under high pressure process, being almost constant in LDPE. We found the average amount of B5 if quantified as C7 at 1.46 wt.-%. With this assumption it is possible to estimate the LDPE content within certain ranges (approximately between 20 wt.-% and 80 wt.-%), which are depending on the SNR ratio of the threeB5 signal: wt.-% LDPE=wtC7total*100/1.46

### REFERENCES

| | |
|---|---|
| zhou07 | Zhou, Z., Kuemmerle, R., Qiu, X., Redwine, D., Cong, R., Taha, A., |
| | Baugh, D. Winniford, B., J. Mag. Reson. 187 (2007) 225 |
| busico07 | Busico, V., Carbonniere, P., Cipullo, R., Pellecchia, R., Severn, J., |
| | Talarico, G., Macromol. Rapid Commun. 2007, 28, 1128 |
| singh09 | Singh, G., Kothari, A., Gupta, V., Polymer Testing 28 5 (2009), 475 |
| randall89 | J. Randall, Macromol. Sci., Rev. Macromol. Chem. Phys. 1989, C29, 201. |
| brandolini00 | A. J. Brandolini, D. D. Hills, NMR Spectra of Polymers and Polymer |
| | Additives, Marcel Dekker Inc., 2000 |

### d) Impact Strength

The impact strength is determined as Charpy Notched Impact Strength according to ISO 179-1 eA at +23° C. and at 0° C. on compression moulded specimens of 80×10×4 mm prepared according to ISO 17855-2.

### e) Tensile Testing of 5A Specimen

For tensile testing, dog bone specimens of 5A are prepared according to ISO 527-2/5A by die cutting from compression moulded plaques of 2 mm′ thickness. All specimens are conditioned for at least 16 hours at 23° C. and 50% relative humidity before testing.

Tensile properties are measured according to ISO 527-1/2 at 23° C. and 50% relative humidity with Alwetron R24, 1 kN load cell. Tensile testing speed is 50 mm/min, grip distance is 50 mm and gauge length is 20 mm.

### f) Rheological Measurements

### Dynamic Shear Measurements (Frequency Sweep Measurements)

The characterisation of melt of polymer composition or polymer as given above or below in the context by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( i ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan 6 which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$${η}^{″} = \frac{{G}^{′}}{ω} [ Pa \cdot s ] \qquad ( 8 )$$

The determination of so-called Shear Thinning Index, which correlates with MWD and is independent of Mw, is done as described in equation 9.

$${SHI}_{( x / y )} = \frac{Eta ⋆ for ( {G}^{*} = x kPa )}{Eta ⋆ for ( {G}^{{*}_{=}} y kPa} \qquad ( 9 )$$

For example, the SHI_{(2.7/210)} is defined by the value of the complex viscosity, in Pa·s, determined for a value of G* equal to 2.7 kPa, divided by the value of the complex viscosity, in Pa·s, determined for a value of G* equal to 210 kPa.

The values of storage modulus (G′), loss modulus (G″), complex modulus (G*) and complex viscosity (η*) were obtained as a function of frequency (ω).

Thereby, e.g. η*_{300 rad/s} (eta*_{300 rads} or eta₃₀₀) is used as abbreviation for the complex viscosity at the frequency of 300 rad/s and η*_{0.05 rad/s} (eta*_{0.05 rad/s} or eta_{0.05}) is used as abbreviation for the complex viscosity at the frequency of 0.05 rad/s.

The polydispersity index, PI, is defined by equation 10.

$$PI = \frac{{10}^{5}}{{G}^{′} ( {ω}_{C O P} )} , {ω}_{COP} = ω for ( G ’ = {G}^{′} ’ ) \qquad ( 10 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate γ-values to x-values from parameter” and the “logarithmic interpolation type” were applied.

### REFERENCES

[1] Rheological characterization of polyethylene fractions” Heino, E. L., Lehtinen, A., Tanner J., Seppala, J., Neste Oy, Porvoo, Finland, Theor. Appl. Rheol., Proc. Int. Congr. Rheol, 11th (1992), 1, 360-362
[2] The influence of molecular structure on some rheological properties of polyethylene”, Heino, E. L., Borealis Polymers Oy, Porvoo, Finland, Annual Transactions of the Nordic Rheology Society, 1995.).
[3] Definition of terms relating to the non-ultimate mechanical properties of polymers, Pure & Appl. Chem., Vol. 70, No. 3, pp. 701-754, 1998.

### g) Large Amplitude Oscillatory Shear (LAOS)

The investigation of the non-linear viscoelastic behaviour under shear flow was done resorting to Large Amplitude Oscillatory Shear. The method requires the application of a sinusoidal strain amplitude, γ₀, imposed at a given angular frequency, ω, for a given time, t. Provided that the applied sinusoidal strain is high enough, a non-linear response is generated. The stress, σ, is in this case a function of the applied strain amplitude, time and the angular frequency. Under these conditions, the non-linear stress response is still a periodic function; however, it can no longer be expressed by a single harmonic sinusoid. The stress resulting from linear viscoelastic response [1-3] can be expressed by a Fourier series, which includes higher harmonics contributions:

$$σ ( t , ω , {γ}_{0} ) = {γ}_{0} \cdot {\sum }_{n} [ {G}_{n}^{′} ( ω , {γ}_{0} ) \cdot sin ( n ω t ) + {G}_{n}^{″} ( ω , {γ}_{0} ) \cdot cos ( n ω t ) ]$$

with
σ=stress response
t=time
ω>=frequency
γ₀=strain amplitude
n=harmonic number
G′ₙ=n order elastic Fourier coefficient
G″ₙ=n order viscous Fourier coefficient

The non-linear viscoelastic response was analysed applying Large Amplitude Oscillatory Shear (LAOS). Time sweep measurements were undertaken on an RPA 2000 rheometer from Alpha Technologies coupled with a standard biconical die. During the course of the measurement the test chamber is sealed and a pressure of about 6 MPa is applied. The LAOS test is done applying a temperature of 190° C., an angular frequency of 0.628 rad/s and a strain of 1000% (LAOS_{NLF} (1000%)). In order to ensure that steady state conditions are reached, the non-linear response is only determined after at least 20 cycles per measurement are completed. The Large Amplitude Oscillatory Shear Non-Linear Factor (LAOS_{NLF}) is defined by:

$${LAOS}_{N L F} ( X \% ) = \vert \frac{{G}_{1}^{′}}{{G}_{3}^{′}} \vert$$

with
G′₁=first order elastic Fourier coefficient
G′₃=third order elastic Fourier coefficient

### REFERENCES

1. J. M. Dealy, K. F. Wissbrun, Melt Rheology and Its Role in Plastics Processing: Theory and Applications; edited by Van Nostrand Reinhold, New York (1990)
2. S. Filipe, Non-Linear Rheology of Polymer Melts, AIP Conference Proceedings 1152, pp. 168-174 (2009) 3.
3. M. Wilhelm, Macromol. Mat. Eng. 287, 83-105 (2002)
4. S. Filipe, K. Hofstadler, K. Klimke, A. T. Tran, Non-Linear Rheological Parameters for Characterisation of Molecular Structural Properties in Polyolefins, Proceedings of Annual European Rheology Conference, 135 (2010)
5. S. Filipe, K. Klimke, A. T. Tran, J. Reussner, Proceedings of Novel Non-Linear Rheological Parameters for Molecular Structural Characterisation of Polyolefins, Novel Trends in Rheology IV, Zlin, Check Republik (2011)
6. K. Klimke, S. Filipe, A. T. Tran, Non-linear rheological parameters for characterization of molecular structural properties in polyolefins, Proceedings of European Polymer Conference, Granada, Spain (2011)

### h) Melting Temperature Tm, Glass Transition Temperature Tg

Temperature Modulated Differential Scanning Calorimetry (TM-DSC) experiments were run on a TA Instruments Q2000 device calibrated with Indium, Zinc, and Tin according to ISO 11357/1. The measurements were run under nitrogen atmosphere (50 mL min⁻¹) on 5±1 mg samples in a heat/cool/heat cycle with a scan rate of 10° C./min between −80° C. and 180° C. according to ISO 11357/3 for the first heating run and the cooling run. The second heating run was performed in a modulated fashion, in particular modulating the temperature of 0.32° C. every 60 seconds while heating the sample at 2° C./min. The reversing heat flow was used to estimate the glass transition temperature Tg, identified as the inversion point as calculated by the Universal Analysis software of TA Instruments. A second cooling step, performed with cooling rate of 10° C./min was afterwards performed in order to recreate the same standard morphology and a final heating step, with 50° C./min heating rate was performed. The melting temperature Tm was measured on this trace as the maximum observed in the curve.

### i) ESCR (Bell Test, h)

By the term ESCR (environmental stress cracking resistance) is meant the resistance of the polymer to crack formation under the action of mechanical stress and a reagent in the form of a surfactant. The ESCR is determined in accordance with IEC 60811-406, method A. The reagent employed is 10 weight % Igepal CO 630 in water. The materials were prepared according to instructions for LLDPE as follows: The materials were pressed at 165° C. to a thickness of 3.00 to 3.30 mm.

### j) Shore D Hardness

Two different Shore D hardness measurements were conducted:

Firstly, Shore D hardness is determined according to ISO 868 on moulded specimen with a thickness of 4 mm. The shore hardness is determined after 1 sec, 3 sec or 15 sec after the pressure foot is in firm contact with the test specimen. The sample is compression moulded

### k) Strain Hardening (SH) Modulus

The strain hardening test is a modified tensile test performed at 80° C. on a specially prepared thin sample. The Strain Hardening Modulus (MPa), <Gp>, is calculated from True Strain-True Stress curves; by using the slope of the curve in the region of True Strain, λ, is between 8 and 12.

The true strain, λ, is calculated from the length, 1 (mm), and the gauge length, 10 (mm), as shown by Equation 1.

$$λ = \frac{l}{{l}_{0}} = 1 + \frac{Δ l}{{l}_{0}} \qquad ( 1 )$$

where Δl is the increase in the specimen length between the gauge marks, (mm). The true stress, σtrue (MPa), is calculated according to formula 2, assuming conservation of volume between the gauge marks:

$${σ}_{true} = {σ}_{n} λ \qquad ( 2 )$$

where σn is the engineering stress.

The Neo-Hookean constitutive model (Equation 3) is used to fit the true strain-true stress data from which <Gp> (MPa) for 8<λ<12 is calculated.

$${σ}_{true} = \frac{〈 Gp 〉}{20} ( {λ}^{2} - \frac{1}{λ} ) + C \qquad ( 3 )$$

where C is a mathematical parameter of the constitutive model describing the yield stress extrapolated to λ=0.

Initially five specimens are measured. If the variation coefficient of <Gp> is greater than 2,5%, then two extra specimens are measured. In case straining of the test bar takes place in the clamps the test result is discarded.

The PE granules of materials were compression molded in sheets of 0.30 mm thickness according to the press parameters as provided in ISO 17855-2.

After compression molding of the sheets, the sheets were annealed to remove any orientation or thermal history and maintain isotropic sheets. Annealing of the sheets was performed for 1 h in an oven at a temperature of (120±2) ° C. followed by slowly cooling down to room temperature by switching off the temperature chamber. During this operation free movement of the sheets was allowed.

Next, the test pieces were punched from the pressed sheets. The specimen geometry of the modified ISO 37:1994 Type 3 (FIG. 3) was used.

The sample has a large clamping area to prevent grip slip, dimensions given in Table 1.

TABLE 1
Dimensions of Modified ISO 37: 1994 Type 3

| Dimension | | Size (mm) |
|---|---|---|
| L | start length between clamps | 30.0 +/− 0.5 |
| l0 | Gauge length | 12.5 +/− 0.1 |
| l1 | Prismatic length | 16.0 +/− 1.0 |
| l3 | Total length | 70 |
| R1 | Radius | 10.0 +/− 0.03 |
| R2 | Radius | 8.06 +/− 0.03 |
| b1 | Prismatic width | 4.0 +/− 0.01 |
| b2 | Clamp width | 20.0 +/− 1.0 |
| h | Thickness | 0.30 + 0.05/0.30 − 0.03 |

The punching procedure is carried out in such a way that no deformation, crazes or other irregularities are present in the test pieces.

The thickness of the samples was measured at three points of the parallel area of the specimen; the lowest measured value of the thickness of these measurements was used for data treatment.
1. The following procedure is performed on a universal tensile testing machine having controlled temperature chamber and non-contact extensometer:
2. Condition the test specimens for at least 30 min in the temperature chamber at a temperature of (80±1) ° C. prior to starting the test.
3. Clamp the test piece on the upper side.
4. Close the temperature chamber.
5. Close the lower clamp after reaching the temperature of (80±1) ° C.
6. Equilibrate the sample for 1 min between the clamps, before the load is applied and measurement starts.
7. Add a pre-load of 0.5 N at a speed of 5 mm/min.
8. Extend the test specimen along its major axis at a constant traverse speed (20 mm/min) until the sample breaks.
   During the test, the load sustained by the specimen is measured with a load cell of 200 N.
   The elongation is measured with a non-contact extensometer.

### l) Water Content

The water content was determined as described in ISO15512:2019 Method A—Extraction with anhydrous methanol. There the test portion is extracted with anhydrous methanol and the extracted water is determined by a coulometric Karl Fischer Titrator.

### m) Cable Extrusion

The cable extrusion is done on a Nokia-Maillefer cable line. The extruder has five temperature zones with temperatures of 170/175/180/190/190° C. and the extruder head has three zones with temperatures of 210/210/210° C. The extruder screw is a barrier screw of the design Elise. The die is a semi-tube on type with 5.9 mm diameter and the outer diameter of the cable is 5 mm. The compound is extruded on a 3 mm in diameter, solid aluminum conductor to investigate the extrusion properties. Line speed is 75 m/min. The pressure at the screen and the current consumption of the extruder is recorded for each material.

### n) Pressure Deformation

Pressure test is conducted according to EN 60811-508. An extruded cable sample is placed in an air oven at a 115° C. and subjected to a constant load applied by means of a special indentation device (with a rectangular indentation 0.7 mm wide knife) for 6 hours. The percentage of indentation is measured afterwards using a digital gauge.

### o) Tensile Testing of Cable

Tensile testing of cable is conducted according to EN60811-501. At least 24 hours later after cable extrusion, the conductor is removed and the cable is cut into specimens of 15 cm's long. The specimens are conditioned for at least 16 hours at 23° C. and 50% relative humidity before testing.

Tensile properties are measured at 23° C. and 50% relative humidity with Zwick Z005, 500N load cell. Tensile testing speed is 25 mm/min, grip distance is 50 mm and gauge length is 20 mm.

### p) Cable Shrinkage

The shrinkage of the composition is determined with the cable samples obtained from the cable extrusion. The cables are conditioned in the constant room at least 24 hours before the cutting of the samples. The conditions in the constant room are 23±2° C. and 50±5% humidity. Samples are cut to 400 mm at least 2 m away from the cable ends. They are further conditioned in the constant room for 24 hours after which they are place in an oven on a talcum bed at 100° C. for 24 hours. After removal of the sample from the oven they are allowed to cool down to room temperature and then measured. The shrinkage is calculated according to formula below:

[(L_{Before}−L_{After})/L_{Before}]×100%,

wherein L is length.

### q) Amount of Limonene

This method allows nature of a raw mixed-plastic-polyethylene primary recycling blend to be determined.

Limonene quantification was carried out using solid phase microextraction (HS-SPME-GC-MS) by standard addition.

20 mg cryomilled samples were weighed into 20 mL headspace vials and after the addition of limonene in different concentrations and a glass-coated magnetic stir bar, the vial was closed with a magnetic cap lined with silicone/PTFE. Micro capillaries (10 pL) were used to add diluted limonene standards of known concentrations to the sample. Limonene was added to the samples to obtain concentration levels of 1 mg/kg, 2 mg/kg, 3 mg/kg and 4 mg/kg limonene. For quantification, ion-93 acquired in SIM mode was used. Enrichment of the volatile fraction was carried out by headspace solid phase microextraction with a 2 cm stable flex 50/30 μm DVB/Carboxen/PDMS fibre at 60° C. for 20 minutes. Desorption was carried out directly in the heated injection port of a GCMS system at 270° C.

GCMS Parameters:

Column: 30 m HP 5 MS 0.25*0.25

Injector: Splitless with 0.75 mm SPME Liner, 270° C.

Temperature program: −10° C. (1 min)

MS: Single quadrupole, direct interface, 280° C. interface temperature

Acquisition: SIM scan mode

Scan parameter: 20-300 amu

SIM Parameter: m/Z 93, 100 ms dwell time

### r) Gel Content

The gel count was measured with a gel counting apparatus consisting of a measuring extruder, ME 25/5200 V1, 25*25D, with five temperature conditioning zones adjusted to a temperature profile of 170/180/190/190/190° C.), an adapter and a slit die (with an opening of 0.5*150 mm). Attached to this were a chill roll unit (with a diameter of 13 cm with a temperature set of 50° C.), a line camera (CCD 4096 pixel for dynamic digital processing of grey tone images) and a winding unit.

For the gel count content measurements the materials were extruded at a screw speed of 30 rounds per minute, a drawing speed of 3-3.5 m/min and a chill roll temperature of 50° C. to make thin cast films with a thickness of 70 μm and a width of approximately 110 mm. The resolution of the camera is 25 μm×25 μm on the film.

The camera works in transmission mode with a constant grey value (auto.set. margin level=170). The system is able to decide between 256 grey values from black=0 to white=256.

For detecting gels, a sensitivity level dark of 25% is used.

For each material the average number of gel dots on a film surface area of 10 m² was inspected by the line camera. The line camera was set to differentiate the gel dot size according to the following:

Gel size (the size of the longest dimension of a gel)

300 μm to 599 μm

600 μm to 999 μm

above 1000 μm

### 2. Materials

LE8706 is a natural bimodal linear low density polyethylene jacketing compound for energy and communication cables (available from Borealis AG).

FB2230 is a natural high molecular weight linear low density polyethylene film grade (available from Borealis AG).

Queo 6800LA is an ethylene based 1-octene elastomer having a density of 868 kg/m³, a melt flow rate (190° C., 2.16 kg) of 0.5 g/10 min, a melting temperature Tm of 47° C., a glass transition temperature Tg of −53° C., and a flexural modulus of 8 MPa (available from Borealis AG).

Additive package: The additive package consists of 27.3 wt.-% of pentaerythrityl-tetrakis(3-(3′,5′-di-tert. butyl-4-hydroxyphenyl)-propionate (CAS No. 6683-19-8), 9.1 wt.-% of tris (2,4-di-t-butylphenyl) phosphite (CAS No. 31570-04-4), 9.1 wt.-% of calcium stearate (CAS No. 1592-23-0) and 54.5 wt.-% of poly((6-((1,1,3,3-tetramethylbutyl)amino)-1,3,5-triazine-2,4-diyl)(2,2,6,6-tetramethyl-4-piperidyl)imino)-1,6-hexanediyl ((2,2,6,6-tetramethyl-4-piperidyl)imino)) (CAS No. 71878-19-8).

NAV 101 and NAV 102 are low density polyethylene (LDPE) post-consumer recyclate blends available from Ecoplast Kunststoffrecycling GmbH. Samples of NAV 101 and NAV 102 (two batches: NAV 102-1, NAV-102-2) differing as to density, melt flow rate and also rheology were tested, the properties of these samples are shown in table A.

The limonene content of the NAV 101 and NAV 102 batches is in the range of from 2.0 to 15.0 mg/kg.

TABLE A
Properties of NAV 101, NAV 102-1 and NAV 102-2

| | NAV 101 | NAV 102-1 | NAV 102-2 |
|---|---|---|---|
| Ethylene content (wt.-%) | 90.67 | 93.05 | 93.00 |
| Isol. C3 content (wt.-%) | n.m. | 0.11 | 0.10 |
| C4 content (wt.-%) | 2.23 | 1.62 | 1.71 |
| C6 content (wt.-%) | 2.73 | 2.95 | 3.23 |
| C7 content (wt.-%) | 0.48 | 0.90 | 0.78 |
| iPP content (wt.-%) | 3.89 | 1.27 | 1.19 |
| LDPE content (wt.-%) | 33.00 | 61.82 | 53.42 |
| Density (kg/m³) | 923.9 | 930.4 | 930.3 |
| Ash content (wt.-%) | | | 0.80 |
| MFR₂ (g/10 min) | 1.02 | 0.59 | 0.56 |
| MFR₅ (g/10 min) | 3.57 | 2.18 | 2.21 |
| MFR₂₁ (g/10 min) | 41.56 | 28.79 | 30.02 |
| SHI_{2.7/210} | 22.16 | 39.92 | n.m. |
| eta_{0.05} (Pa · s) | 16187 | 27185 | 25908 |
| eta₃₀₀ (Pa · s) | 618 | 626 | 600 |
| LAOS_{NLF} (1000%) | | | 3.785 |
| PI (s⁻¹) | 1.46 | 2.31 | 2.37 |
| SH modulus (MPa) | 14.3 | | n.m. |
| ω_{COP} | 78.25 | 25.98 | 26.47 |
| Impact strength, 23° C., (kJ/m²) | | | 63.48 |
| Shore D 15 s (ISO 868) | | | 48.4 |
| Shore D 1 s (ISO 868) | | | 53.5 |
| Shore D 3 s (ISO 868) | | | 51.4 |
| Gel content (≥1000 μm) (1/m²) | 16.9 | 28.7 | 97.7 |
| Gel content (600-999 μm) (1/m²) | 175.1 | 167.9 | 519.1 |
| Gel content (300-599 μm) (1/m²) | 885.9 | 997.9 | 3377.4 |

n.m = not measurable

### 3. Experiments

### a) Comparative Examples

Comparative example 1 (CE1) are 100% reactor-made LE8706 pellets.

Comparative example 2 (CE2) is 100% reactor-made FB2230 pellets.

Comparative example 3 (CE3): 99.2 wt.-% of NAV 102-1 was melt mixed with 0.8 wt.-% additive package.

### b) Inventive Examples

In inventive example 1 (IE1), 74.8 wt.-% LE8706 was melt mixed with 25 wt.-% NAV 102-1 and 0.3 wt.-% additive package.

In inventive example 2 (IE2) 49.6 wt.-% LE8706 was melt mixed with 50 wt.-% NAV 102-1 and 0.4 wt.-% additive package.

In inventive example 3 (IE3) 24.4 wt.-% LE8706 was melt mixed with 75 wt.-% NAV 102-1 and 0.6 wt.-% additive package.

In inventive example 4 (IE4) 44.52 wt.-% LE8706 was melt mixed with 50 wt.-% NAV 102-1, 5 wt.-% Queo 6800LA and 0.48 wt.-% additive package.

In inventive example 5 (IE5) 39.52 wt.-% LE8706 was melt mixed with 50 wt.-% NAV 102-1, 10 wt.-% Queo 6800LA and 0.44 wt.-% additive package.

In inventive example 6 (IE6) 34.48 wt.-% LE8706 was melt mixed with 50 wt.-% NAV 102-1, 15 wt.-% Queo 6800LA and 0.44 wt.-% additive package.

In inventive example 7 (IE7) 49.6 wt.-% LE8706 was melt mixed with 50 wt.-% NAV 101 and 0.4 wt.-% additive package.

In inventive example 8 (IE8) 49.4 wt.-% FB2230 was melt mixed with 50 wt.-% NAV 102-1 and 0.6 wt.-% additive package.

In inventive example 9 (IE9) 24.4 wt.-% FB2230 was melt mixed with 75 wt.-% NAV 102-1 and 0.6 wt.-% additive package.

In inventive example 10 (IE10) 39.4 wt.-% FB2230 was melt mixed with 50 wt.-% NAV 102-1, 10 wt.-% Queo 6800LA and 0.6 wt.-% additive package.

In inventive example 11 (IE11) 34.4 wt.-% FB2230 was melt mixed with 50 wt.-% NAV 102-2, 15 wt.-% Queo 6800LA and 0.6 wt.-% additive package.

The compositions of examples CE1, CE2, CE3 and IE1-IE11 were prepared via melt blending on a co-rotating twin screw extruder (Coperion ZSK32 Megacompounder, L/D=48) at 150° C. in the first barrel after the feeding zone and 220-230° C. in all the following barrels, a screw speed of 120 rpm and a throughput rate of about 15-25 kg/h. The polymer melt mixtures were discharged and pelletized. Mechanical properties were tested as described above. Thereby, the final MFR of the compounds is influenced by the compounding condition, e.g. the screw speed.

The properties of the compositions and cables made from these compositions are shown below in Table B for the compositions of examples CE1, CE3, IE1-IE7 and in Table C for the compositions of examples CE2, CE3 and IE8-IE11.

The examples according to the invention show an improved balance of properties especially in regard of ESCR, flexural modulus and Charpy Notched Impact Strength while maintaining good tensile properties, SH index and Shore D hardness. The examples according to the invention also show good pressure deformation behaviour and good properties when cast into cable layers, such as low cable shrinkage, and good tensile properties.

By adding low amounts of VLDPE in form of an elastomer the flexural modulus can be further lower, thereby increasing the flexibility, without sacrificing the tensile properties and impact properties.

The > in the ESCR data means that the measurement is still running or measurement was stopped without any failure.

TABLE B
Properties of CE1, CE3, IE1-IE7

| | CE1 | CE3 | IE1 | IE2 | IE3 | IE4 | IE5 | IE6 | IE7 |
|---|---|---|---|---|---|---|---|---|---|
| Ethylene content (wt.-%) | 91.84 | 93.25 | 92.47 | 92.67 | 92.92 | 92.89 | 93.56 | 94.10 | 91.50 |
| isol. C3 content (wt.-%) | n.m. | n.m. | n.m. | n.m. | n.m. | n.m. | n.m. | n.m. | n.m. |
| C4 content (wt.-%) | 8.16 | 1.81 | 6.53 | 5.13 | 3.39 | 4.56 | 4.12 | 3.66 | 5.26 |
| C6 content (wt.-%) | n.m. | 2.84 | 0.64 | 1.24 | 2.20 | 1.58 | 1.32 | 1.17 | 1.53 |
| C7 content (wt.-%) | n.m. | 0.78 | n.m. | 0.25 | 0.44 | 0.27 | 0.39 | 0.37 | 0.34 |
| iPP content (wt.-%) | n.m. | 1.32 | 0.36 | 0.70 | 1.04 | 0.69 | 0.62 | 0.71 | 1.37 |
| LDPE content (wt.-%) | n.m. | 53.43 | n.m. | 17.26 | 30.19 | 18.83 | 26.45 | 25.28 | 23.09 |
| Density (kg/m³) | 923.3 | 931.0 | 925.4 | 927.2 | 929.0 | 924.4 | 921.5 | 918.5 | 924.0 |
| MFR₂ (g/10 min) | 0.86 | 0.56 | 0.72 | 0.74 | 0.32 | 0.65 | 0.68 | 0.65 | 0.94 |
| MFR₅ (g/10 min) | 3.57 | 2.20 | 3.03 | 2.65 | 2.38 | 2.48 | 2.24 | 2.38 | 3.56 |
| MFR₂₁ (g/10 min) | 73.97 | 28.60 | 49.6 | 44.92 | 34.22 | 36.30 | 35.72 | 25.28 | 53.30 |
| SHI_{2.7/210} | 31.69 | 41.72 | 32.02 | 32.85 | 34.60 | 30.22 | 28.35 | 27.10 | 25.41 |
| eta_{0.05} (Pa · s) | 17695 | 24880 | 18008 | 20146 | 22479 | 20568 | 20775 | 21147 | 15918 |
| eta₃₀₀ (Pa · s) | 600 | 584 | 588 | 604 | 610 | 630 | 651 | 665 | 599 |
| PI (s⁻¹) | 2.48 | 2.30 | 2.39 | 2.29 | 2.26 | 2.12 | 1.98 | 1.91 | 1.88 |
| SH modulus (MPa) | 16.17 | n.m. | 14.94 | 15.16 | 14.31 | 12.26 | 10.31 | n.m. | 14.39 |
| ω_{COP} | 21.93 | 30.88 | 25.82 | 27.67 | 28.92 | 30.04 | 32.55 | 33.74 | 46.08 |
| Flexural modulus [MPa] | 409 | 383 | 448 | 425 | 405 | 354 | 353 | 295 | 414 |
| Impact strength, 23° C., (kJ/m²) | 78.24 | 57.15 | 75.17 | 71.07 | 66.36 | 74.12 | 72.79 | 71.32 | 74.32 |
| Impact strength, 0° C., (kJ/m²) | 93.15 | 9.49 | 83.36 | 66.41 | 24.16 | 87.85 | 89.90 | 86.67 | 82.40 |
| Shore D 15 s (ISO 868) | 47.0 | 49.0 | 48.3 | 48.7 | 48.7 | 45.5 | 45.5 | 43.2 | 48.5 |
| Shore D 1 s (ISO 868) | 51.7 | 52.9 | 52.7 | 53.1 | 52.1 | 49.9 | 49.4 | 47.2 | 52.0 |
| Shore D 3 s (ISO 868) | 49.0 | 51.3 | 50.4 | 50.5 | 50.6 | 48.1 | 48.1 | 44.9 | 50.5 |
| ESCR (h) | >5000 | | >5000 | >5000 | >5000 | >5000 | >5000 | >5000 | >5000 |
| Tensile strain at | 794.81 | 734.74 | 760.01 | 746.98 | 760.4 | 781.06 | 756.46 | 751.58 | 808.94 |
| break, 5A specimen (%) | | | | | | | | | |
| Tensile stress at | 23.93 | 19.15 | 21.39 | 20.43 | 20.74 | 22.89 | 22.33 | 22.6 | 23.55 |
| break, 5A specimen (MPa) | | | | | | | | | |
| LAOS_{NLF} (1000%) | 1.827 | 3.230 | 2.081 | 2.428 | 2.711 | 2.427 | 2.460 | 2.560 | 2.305 |
| Pressure deformation (%) | 17 | 37 | 18 | 19 | 30 | 28 | 26 | 40 | 23 |
| Water content (%) | 48.4 | 393 | 136.2 | 168.7 | 322.2 | 244.6 | 311.2 | 251.6 | 29.1 |
| Cable shrinkage (%) | 0.25 | 0.66 | 0.38 | 0.61 | 0.55 | 0.68 | 0.59 | 0.33 | 0.41 |
| Tensile strain at | 576.61 | 517.73 | 538.5 | 529.25 | 522.88 | 540.35 | 547.41 | 563.68 | 541.07 |
| break, cable (%) | | | | | | | | | |
| Tensile stress at | 18.12 | 20.32 | 18.63 | 19.05 | 19.57 | 19.62 | 19.77 | 17.95 | 19.17 |
| break, cable (MPa) | | | | | | | | | |

n.m. = not measurable/below the detection limit

TABLE C
Properties of CE2, CE3, IE8-IE11

| | CE2 | CE3 | IE8 | IE9 | IE10 | IE11 |
|---|---|---|---|---|---|---|
| Ethylene content (wt.-%) | 92.55 | 93.25 | 92.98 | 93.08 | 93.72 | 94.76 |
| isol. C3 content (wt.-%) | n.m. | n.m. | n.m. | n.m. | n.m. | n.m. |
| C4 content (wt.-%) | 7.45 | 1.81 | 4.78 | 3.17 | 3.92 | 3.34 |
| C6 content (wt.-%) | n.m. | 2.84 | 1.31 | 2.30 | 1.44 | 1.14 |
| C7 content (wt.-%) | n.m. | 0.78 | 0.30 | 0.51 | 0.31 | 0.23 |
| iPP content (wt.-%) | n.m. | 1.32 | 0.63 | 0.93 | 0.61 | 0.52 |
| LDPE content (wt.-%) | n.m. | 53.43 | 20.72 | 35.24 | 21.37 | 16.07 |
| Density (kg/m³) | 922.8 | 931.0 | 927.1 | 928.8 | 921.3 | 918.4 |
| MFR₂ (g/10 min) | 0.22 | 0.56 | 0.38 | 0.47 | 0.35 | 0.42 |
| MFR₅ (g/10 min) | 0.92 | 2.20 | 1.36 | 1.68 | 1.33 | 1.62 |
| MFR₂₁ (g/10 min) | 22.49 | 28.60 | 22.76 | 25.63 | 21.20 | 23.03 |
| SHI_{2.7/210} | 38.61 | 41.72 | 46.22 | 44.63 | 37.26 | 34.11 |
| eta_{0.05} (Pa · s) | 55076 | 24880 | 38660 | 32710 | 35410 | 34065 |
| eta₃₀₀ (Pa · s) | 895 | 584 | 725 | 669 | 754 | 762 |
| PI (s⁻¹) | 2.66 | 2.30 | 2.92 | 2.75 | 2.36 | 2.18 |
| SH modulus (MPa) | 33.83 | n.m. | 21.48 | 17.49 | 14.85 | 11.02 |
| ω_{COP} | 5.21 | 30.88 | 9.05 | 14.18 | 14.17 | 16.51 |
| Flexural modulus [MPa] | 408 | 383 | 422 | 402 | 345 | 303 |
| Impact strength, 23° C., (kJ/m²) | 79.36 | 57.15 | 79.96 | 74.62 | 74.26 | 71.67 |
| Impact strength, 0° C., (kJ/m²) | 95.55 | 9.49 | 79.61 | 38.6 | 90.87 | 86.17 |
| Shore D 15 s (ISO 868) | 48.2 | 49.0 | 48.3 | 47.9 | 45.5 | 43.6 |
| Shore D 1 s (ISO 868) | 52.2 | 52.9 | 52.1 | 52.7 | 50.1 | 48.3 |
| Shore D 3 s (ISO 868) | 50.0 | 51.3 | 50.2 | 50.6 | 47.6 | 46.1 |
| ESCR (h) | | | >5000 | >5000 | >5000 | >6000 |
| Tensile strain at | 752.15 | 734.74 | 728.12 | 730.68 | 734.93 | 716.21 |
| break, 5A specimen (%) | | | | | | |
| Tensile stress at | 30.66 | 19.15 | 23.25 | 21.34 | 24.44 | 23.17 |
| break, 5A specimen (MPa) | | | | | | |
| LAOS_{NLF} (1000%) | 1.804 | 3.230 | 2.279 | 2.626 | 2.360 | 2.426 |
| Pressure deformation (%) | 16 | 37 | 21 | 31 | 32 | 18 |
| Water content (%) | 157.1 | 393 | 104.7 | 232.7 | 144.2 | 293 |
| Cable shrinkage (%) | 0.27 | 0.66 | 0.56 | 0.40 | 0.60 | 0.72 |
| Tensile strain at | 532.66 | 517.73 | 472.08 | 482.82 | 499.8 | 511.75 |
| break, cable (%) | | | | | | |
| Tensile stress at | 18.43 | 20.32 | 17.30 | 16.67 | 17.22 | 21.05 |
| break, cable (MPa) | | | | | | |

n.m. = not measurable/below the detection limit

1. A mixed-plastic-polyethylene composition comprising:
a total amount of ethylene units (C2 units) of from 90.00 to 99.00 wt. %,
a total amount of continuous units having 3 carbon atoms corresponding to polypropylene (continuous C3 units) of from 0.10 to 5.00 wt. %, and
a total combined amount of units having 4 carbon atoms (C4 units) and units having 6 carbon atoms (C6 units) of from 4.00 to 10.00 wt. %,
with the total amounts of C2 units, continuous C3 units, C4 units and C6 units being based on the total weight amount of monomer units in the composition and measured according to quantitative ¹³C{¹H}NMR measurement,
and wherein the composition has
a melt flow rate (ISO 1133, 2.16 kg, 190° C.) of from 0.1 to 2.0 g/10 min; and
a density of from 910 kg/m³ to 945 kg/m³.

2. The mixed-plastic polyethylene composition according to claim 1, obtained by blending and extruding components comprising:
a) 25 to 85 wt. %, based on the overall weight of the composition, of a mixed-plastic-polyethylene primary recycling blend (A),
wherein at least 90 wt. % of the mixed-plastic-polyethylene primary blend (A) originates from post-consumer waste and/or post-industrial waste having a limonene content of from 0.1 to 500 mg/kg; and wherein the mixed-plastic-polyethylene primary blend (A) has
a melt flow rate (ISO 1133, 2.16 kg, 190° C.) of from 0.1 to 2.0 g/10 min;
a density of from 910 to 945 kg/m³; and
a total amount of ethylene units (C2 units) of from 80.00 to 96.00 wt. %,
with the total amount of C2 units being based on the total weight amount of monomer units in the mixed-plastic-polyethylene primary blend (A) and measured according to quantitative ¹³C{¹H}NMR measurement; and
b) 15 to 75 wt. %, based on the overall weight of the composition, of a secondary blend (B) of virgin linear low-density polyethylene (LLDPE), wherein the secondary blend (B) has
ethylene monomer units and comonomer units derived from olefins having from 3 to 6 carbon atoms,
a melt flow rate (ISO 1133, 2.16 kg, 190° C.) of from 0.10 to 1.5 g/10 min; and
a density of from 900 to <940 kg/m³.

3. The mixed-plastic polyethylene composition according to claim 1, obtained by blending and extruding components comprising:
a) 25 to 84 wt. %, based on the overall weight of the composition, of the mixed-plastic-polyethylene primary recycling blend (A);
b) 15 to 65 wt. %, based on the overall weight of the composition, of the secondary blend (B) of virgin linear low-density polyethylene (LLDPE); and
c) 1 to 20 wt. %, based on the overall weight of the composition, of a component (C) of virgin very low-density polyethylene (VLDPE), the blend (C) having,
ethylene monomer units and comonomer units derived from olefins having from 3 to 12 carbon atoms,
a melt flow rate (ISO 1133, 2.16 kg, 190° C.) of from 0.1 to 1.5 g/10 min, and
a density of from 840 to <900 kg/m³.

4-6. (canceled)

7. The mixed-plastic-polyethylene composition according to claim 1, having a Charpy Notched Impact Strength at 23° C. of from 65 to 100 kJ/m², and/or a Charpy Notched Impact Strength at 0° C. of from 20 to 120 kJ/m², when measured according to ISO 179 eA.

8. The mixed-plastic polyethylene composition according to claim 1, comprising one or more or all of the following properties:
a total amount of ethylene units (C2 units) of from 90.00 to 99.00 wt. %,
a total amount of continuous units having 3 carbon atoms corresponding to polypropylene (continuous C3 units) of from 0.10 to 5.00 wt. %,
a total amount of units having 3 carbon atoms as isolated peaks in the NMR spectrum (isolated C3 units) of from 0 wt. % to 0.50 wt.;
a total amount of units having 4 carbon atoms (C4 units) of from 0.50 wt. % to 8.00 wt. %;
a total amount of units having 6 carbon atoms (C6 units) of from 0.30 wt. % to 6.00 wt. %;
a total combined amount of units having 4 carbon atoms (C4 units) and units having 6 carbon atoms (C6 units) of from 4.00 to 10.00 wt. %,
a total amount of units having 7 carbon atoms (C7 units) of from 0 wt. % to 1.00 wt. %;
a LDPE content of from 7.50 to 50.00 wt. %,
wherein the total amounts of C2 units, continuous C3 units, isolated C3 units, C4 units, C6 units, C7 units and LDPE content are based on the total weight amount of monomer units in the composition and are measured or calculated according to quantitative ¹³C{¹H}NMR measurement.

9. The mixed-plastic-polyethylene composition according to claim 1, wherein the composition has one or more or all of the following properties:
a melt flow rate (ISO 1133, 5 kg, 190° C.) of from 1.0 to 5.0 g/10 min, and/or
a melt flow rate (ISO 1133, 21.6 kg, 190° C.) of from 15 to 70 g/10 min, and/or
a shear thinning index SHI_{(2.7/210)} of from 18 to 60, and/or
a complex viscosity at 0.05 rad/s eta_{0.05} rad/s of from 10000 to 45000 Pa·s, and/or
a complex viscosity at 300 rad/s eta_{300 rad/s} of from 500 to 900 Pa·s, and/or
a polydispersity index PI of from 1.0 to 4.0 s⁻¹, and/or
a strain hardening modulus (SH modulus) of from 7.5 to 25.0 MPa, and/or
an ESCR (Bell test failure time) of more than 2500 hours.

10. The mixed-plastic-polyethylene composition according to claim 1, wherein the composition comprises carbon black and has a density of from 920 kg/m³ to 945 kg/m³, or the composition is free from carbon black and has a density of from 910 kg/m³ to 935 kg/m³.

11. An article comprising the mixed-plastic-polyethylene composition according to claim 1, wherein the article is a cable comprising at least one layer comprising the mixed-plastic-polyethylene composition, or wherein the article is a cable comprising a jacketing layer comprising the mixed-plastic-polyethylene composition.

12. A process for preparing the mixed-plastic-polyethylene composition according to claim 1, comprising the steps of:
a) providing a mixed-plastic-polyethylene primary recycling blend (A) in an amount of 25 to 85 wt. % based on the overall weight of the composition,
wherein at least 90 wt. % of the mixed-plastic-polyethylene primary blend (A) originates from post-consumer waste and/or post-industrial waste wherein the mixed-plastic-polyethylene primary blend (A) has:
a melt flow rate (ISO 1133, 2.16 kg, 190° C.) of from 0.1 to 2.0 g/10 min;
a density of from 910 to 945 kg/m³;
a total amount of ethylene units (C2 units) of from 80.00 to 96.00 wt. %,
with the total amounts of C2 units being based on the total weight amount of monomer units in the mixed-plastic-polyethylene primary recycling blend (A) and measured according to quantitative ¹³C{¹H}NMR measurement;
b) providing a secondary blend (B) of virgin linear low-density polyethylene (LDPE) in an amount of 15 to 75 wt. % based on the overall weight of the composition, wherein the secondary blend (B) has,
ethylene monomer units and comonomer units derived from olefins having from 3 to 6 carbon atoms,
a melt flow rate (ISO 1133, 2.16 kg, 190° C.) of from 0.10 to 1.5 g/10 min; and
a density of from 900 to <940 kg/m³;
c) melting and mixing the blend of the polyethylene blend (A) and the secondary blend (B) in an extruder, optionally a twin screw extruder, and
d) optionally pelletizing the obtained mixed-plastic-polyethylene composition.

13. The process according to claim 12, comprising the steps of:
a) providing the mixed-plastic-polyethylene primary recycling blend (A) in an amount of 25 to 84 wt. % based on the overall weight of the composition;
b) providing the secondary blend (B) of virgin linear low-density polyethylene (LLDPE) in an amount of 15 to 80 wt. % based on the overall weight of the composition;
c) providing a component (C) of virgin very low-density polyethylene (VLDPE) in an amount of 1 to 20 wt.-% based on the overall weight of the composition, wherein the component (C) has,
ethylene monomer units and comonomer units derived from olefins having from 3 to 12 carbon atoms,
a melt flow rate (ISO 1133, 2.16 kg, 190° C.) of from 0.1 to 1.5 g/10 min, and
a density of from 840 to <900 kg/m³,
d) melting and mixing the blend of polyethylene blend (A), the secondary blend (B) and the component (C) in an extruder, optionally a twin screw extruder, and
e) optionally pelletizing the obtained mixed-plastic-polyethylene composition.

14. (canceled)

15. A mixed-plastic-polyethylene composition having:
a melt flow rate (ISO 1133, 2.16 kg, 190° C.) of from 0.1 to 2.0 g/10 min;
a density of from 910 kg/m³ to 945 kg/m³;
obtained by blending and extruding components comprising
a) 25 to 85 wt. %, based on the overall weight of the composition, of a mixed-plastic-polyethylene primary recycling blend (A),
wherein at least 90 wt. % of the mixed-plastic-polyethylene primary blend (A) originates from post-consumer waste and/or post-industrial waste having a limonene content of from 0.1 to 500 mg/kg; and wherein the mixed-plastic-polyethylene primary blend (A) has,
a melt flow rate (ISO 1133, 2.16 kg, 190° C.) of from 0.1 to 2.0 g/10 min;
a density of from 910 to 945 kg/m³; and
a total amount of ethylene units (C2 units) of from 80.00 to 96.00 wt. %,
with the total amount of C2 units being based on the total weight amount of monomer units in the mixed-plastic-polyethylene primary blend (A) and measured according to quantitative ¹³C{¹H}NMR measurement; and
15 to 75 wt. %, based on the overall weight of the composition, of a secondary blend (B) of virgin linear low-density polyethylene (LLDPE), wherein the secondary blend (B) has,
ethylene monomer units and comonomer units derived from olefins having from 3 to 6 carbon atoms,
a melt flow rate (ISO 1133, 2.16 kg, 190° C.) of from 0.10 to 1.5 g/10 min; and
a density of from 900 to <940 kg/m³.

16. The mixed-plastic-polyethylene composition according to claim 16, having a flexural modulus of from 250 to 500 MPa.

17. The mixed-plastic-polyethylene composition according to claim 16 obtained by blending and extruding components comprising:
a) 25 to 84 wt. %, based on the overall weight of the composition, of the mixed-plastic-polyethylene primary recycling blend (A);
b) 15 to 65 wt. %, based on the overall weight of the composition, of the secondary blend (B) of virgin linear low-density polyethylene (LLDPE); and
c) 1 to 20 wt. %, based on the overall weight of the composition, of a component (C) of virgin very low-density polyethylene (VLDPE), the blend (C) having,
ethylene monomer units and comonomer units derived from olefins having from 3 to 12 carbon atoms,
a melt flow rate (ISO 1133, 2.16 kg, 190° C.) of from 0.1 to 1.5 g/10 min, and
a density of from 840 to <900 kg/m³.

18. The mixed-plastic-polyethylene composition according to claim 16, having a flexural modulus of from 250 to 400 MPa.

19. The mixed-plastic-polyethylene composition according to claim 16, having a Charpy Notched Impact Strength at 23° C. of from 65 to 100 kJ/m², when measured according to ISO 179 eA.

20. The mixed-plastic polyethylene composition according to claim 16, comprising one or more or all of the following properties:
a total amount of ethylene units (C2 units) of from 90.00 to 99.00 wt. %,
a total amount of continuous units having 3 carbon atoms corresponding to polypropylene (continuous C3 units) of from 0.10 to 5.00 wt. %,
a total amount of units having 3 carbon atoms as isolated peaks in the NMR spectrum (isolated C3 units) of from 0 wt. % to 0.50 wt. %;
a total amount of units having 4 carbon atoms (C4 units) of from 0.50 wt. % to 8.00 wt. %;
a total amount of units having 6 carbon atoms (C6 units) of from 0.30 wt. % to 6.00 wt. %;
a total combined amount of units having 4 carbon atoms (C4 units) and units having 6 carbon atoms (C6 units) of from 4.00 to 10.00 wt. %, a total amount of units having 7 carbon atoms (C7 units) of from 0 wt. % to 1.00 wt. %;
a LDPE content of from 7.50 to 50.00 wt. %,
wherein the total amounts of C2 units, continuous C3 units, isolated C3 units, C4 units, C6 units, C7 units and LDPE content are based on the total weight amount of monomer units in the composition and are measured or calculated according to quantitative ¹³C{¹H}NMR measurement.

21. The mixed-plastic-polyethylene composition according claim 16, wherein the composition has one or more or all of the following properties:
a melt flow rate (ISO 1133, 5 kg, 190° C.) of from 1.0 to 5.0 g/10 min, and/or
a melt flow rate (ISO 1133, 21.6 kg, 190° C.) of from 15 to 70 g/10 min, and/or
a shear thinning index SHI_{(2.7/210)} of from 18 to 60, and/or
a complex viscosity at 0.05 rad/s eta_{0.05} rad/s of from 10000 to 45000 Pa·s, and/or
a complex viscosity at 300 rad/s eta_{300 rad/s} of from 500 to 900 Pa·s, and/or
a polydispersity index PI of from 1.0 to 4.0 s⁻¹, and/or
a strain hardening modulus (SH modulus) of from 7.5 to 25.0 MPa, and/or
an ESCR (Bell test failure time) of more than 2500 hours.

22. The mixed-plastic-polyethylene composition according to claim 16, wherein the composition comprises carbon black and has a density of from 920 kg/m³ to 945 kg/m³, or the composition is free from carbon black and has a density of from 910 kg/m³ to 935 kg/m³.

23. An article comprising the mixed-plastic-polyethylene composition according to claim 16, wherein the article is a cable comprising at least one layer comprising the mixed-plastic-polyethylene composition or wherein the article is a cable comprising a jacketing layer comprising the mixed-plastic-polyethylene composition.
